(19) United States
(12) Patent Application Publication
(10) Pub. No.: US 2026/0050551 A1
(43) Pub. Date: Feb. 19, 2026

(54) MATRIX STORAGE METHOD AND APPARATUS

(71) Applicant: HUAWEI TECHNOLOGIES CO., LTD., Shenzhen (CN)

(72) Inventors: Tengyi Lin, Shanghai (CN); Xiao Lu, Hangzhou (CN); Zhiwei Chen, Shenzhen (CN); Chun Yang, Shenzhen (CN); Yigang Zhou, Shanghai (CN); Li Cao, Shanghai (CN); Fei Yi, Xi'an (CN); Yanzhe Zhang, Xi'an (CN)

(73) Assignee: HUAWEI TECHNOLOGIES CO., LTD., Shenzhen (CN)

(21) Appl. No.: 19/368,477

(22) Filed: Oct. 24, 2025

Related U.S. Application Data
(63) Continuation of application No. PCT/CN2024/089679, filed on Apr. 24, 2024.

(30) Foreign Application Priority Data
Apr. 25, 2023 (CN) 202310475926.5
Jul. 14, 2023 (CN) 202310875441.5

(51) Int. Cl. G06F 12/06

(52) U.S. Cl. CPC G06F 12/0646

(57) ABSTRACT

A matrix storage method and apparatus are provided. In the method, a plurality of first sub-blocks corresponding to a to-be-stored original matrix are obtained. The plurality of first sub-blocks are obtained after blocking is performed on the original matrix by using a sub-block with a scale of M₁×N₁ as a unit and a non-zero element in each submatrix obtained through blocking is compressed in a specified direction, where M₁ and N₁ are positive integers. Blocking is performed on each first sub-block by using a sub-block with a scale of M₂×N₂ as a unit to obtain a plurality of second sub-blocks, where M₂ is a positive integer not greater than M₁, and N₂ is a positive integer not greater than N₁. Data of the plurality of second sub-blocks is sequentially stored by using a second sub-block as a unit.

### CROSS-REFERENCE TO RELATED APPLICATIONS

This application is a continuation of International Application No. PCT/CN2024/089679, filed on Apr. 24, 2024, which claims priority to Chinese Patent Application No. 202310875441.5, filed on Jul. 14, 2023 and Chinese Patent Application No. 202310475926.5, filed on Apr. 25, 2023. All of the aforementioned patent applications are hereby incorporated by reference in their entireties.

### TECHNICAL FIELD

This application relates to the field of data processing technologies, and in particular, to a matrix storage method and apparatus.

### BACKGROUND

A sparse matrix data format is a most important data type in artificial intelligence (AI), high-performance computing HPC), graph computing, and graph neural network (GNN) convolution computing. Currently, sparse matrix data formats mainly include a coordinate (COO) format, a compressed sparse row (CSR) format, a compressed sparse column (CSC) format, an ELLPACK (ELL) format, and the like.

Currently, new matrix accelerators such as chips like CPUs, GPUs, NPUs, and PIMs are thriving, and a gap between sparse computing efficiency and dense computing efficiency becomes larger. The existing sparse compression format may not meet requirements of high concurrency of GPUs, vectors, and matrix units. Currently, a new compressed storage manner of a sparse matrix is urgently needed.

### SUMMARY

This application provides a matrix storage method and apparatus, to provide a new compressed storage manner of a sparse matrix.

According to a first aspect, this application provides a matrix storage method. The method may be performed by a device (for example, a computing device) having a data processing function, or may be performed by a component (for example, a processor) in the device. The computing device is used as an example. In the method, the computing device may obtain a plurality of sub-blocks (denoted as first sub-blocks) corresponding to an original matrix. There are a plurality of obtaining manners. For example, the computing device receives the plurality of first sub-blocks input by a user. Alternatively, the computing device obtains the plurality of first sub-blocks stored in the computing device; and the computing device first obtains the original matrix, and then processes the original matrix to obtain the plurality of first sub-blocks.

The plurality of first sub-blocks are obtained after the computing device or another device performs processing like blocking and compression on the original matrix. For example, blocking is performed on the original matrix by using a sub-block with a scale of M₁×N₁ as a unit (where M₁ and N₁ are positive integers) to obtain a plurality of submatrices with the scale of M₁×N₁, and then non-zero elements in each submatrix are compressed in a specified direction (for example, a row direction or a column direction) to obtain the plurality of first sub-blocks.

Then, the computing device performs blocking on each first sub-block by using a sub-block with a scale of M₂×N₂ as a unit to obtain a plurality of second sub-blocks, where M₂ is a positive integer not greater than M₁, and N₂ is a positive integer not greater than N₁. The sub-block scale of M₂×N₂ is smaller than the sub-block scale of M₁×N₁. Data of the plurality of second sub-blocks is sequentially stored by using a second sub-block as a unit.

According to the foregoing design, the plurality of first sub-blocks corresponding to the original matrix are obtained, the plurality of first sub-blocks are obtained by compressing the non-zero elements in the plurality of submatrices of the original matrix in the specified direction, and then tiling may be performed on each first sub-block to obtain the plurality of second sub-blocks corresponding to one first sub-block.

Blocking is performed on the original matrix to obtain the plurality of first sub-blocks. This helps improve a compression rate. The first sub-block is divided into the plurality of second sub-blocks for storage. This can further improve the compression rate. In this way, a sparse matrix with random distribution can be adapted to, and a high compression rate can be maintained under any sparse matrix. A manner of sequentially storing the plurality of second sub-blocks by using a second sub-block as a unit may facilitate memory access, and at least one complete second sub-block can be read in one time of memory access, thereby reducing a quantity of times of accessing a memory during sparse matrix calculation. Because lengths of all rows and lengths of all columns of the second sub-block are consistent, the second sub-block provides a more friendly data access manner for a vector processor or a matrix processor. This can achieve good locality for access in a row order or column order, adapt to a dedicated hardware accelerator with high efficiency, and help improve a degree of parallelism of the sparse matrix calculation. On one hand, a plurality of complete second sub-blocks can be read in one time of memory access, and parallel computation may be performed on the plurality of second sub-blocks by using a plurality of dedicated hardware accelerators respectively. This can improve a degree of multi-core parallelism. On the other hand, because one second sub-block may provide a sufficient data amount for one dedicated hardware accelerator, the second sub-block is more suitable for the dedicated hardware accelerator to accelerate calculation. This helps improve a degree of intra-core parallelism of a single dedicated accelerator, and performance of the dedicated hardware accelerator can be greatly improved.

In a possible implementation, the method further includes:

The computing device obtains subscript data of each first sub-block in a plurality of obtaining manners. For example, the computing device receives the subscript data of each first sub-block that is input by the user. Alternatively, the computing device obtains the subscript data of each first sub-block that is stored in the computing device. Alternatively, the computing device determines the subscript data of each first sub-block based on the obtained original matrix. In some cases, the subscript data of the first sub-block may be obtained together with the first sub-block. This is not specifically limited.

One first sub-block is used as an example. The subscript data of the first sub-block indicates a location (a subscript, that is, a row index and a column index) of each element in the first sub-block in the original matrix. The subscript data of the first sub-block includes an offset value pair, an index matrix, and an index vector that correspond to the first sub-block, which are separately described below.

In an example, when the specified direction is the row direction:
(1) The offset value pair includes a pair of offset values, denoted as a first offset value and a second offset value. The first offset value indicates a first offset of a row, corresponding to an initial row (namely, a start row) of the first sub-block, in the original matrix relative to a start row (for example, a row 0) of the original matrix, and the second offset value indicates a second offset of a column, corresponding to an initial column (namely, a start column) of the first sub-block, in the original matrix relative to a start column (for example, a column 0) of the original matrix.
(2) A value of any element (for example, a first element) in the index matrix is equal to a difference between the second offset and a column index, in the original matrix, of an element that is in the first sub-block and that corresponds to the first element. A plurality of elements in the index matrix one-to-one correspond to a plurality of elements in the first sub-block.
(3) A value of any element (for example, a second element) in the index vector indicates a difference between the first offset and a row index, in the original matrix, of an element that is in the first sub-block and that corresponds to the second element. A plurality of elements in the index vector one-to-one correspond to all rows of the first sub-block.

In another example, when the specified direction is the column direction:
(1) The offset value pair includes a pair of offset values, denoted as a first offset value and a second offset value. The first offset value indicates a first offset of a row, corresponding to an initial row (namely, a start row) of the first sub-block, in the original matrix relative to a start row (for example, a row 0) of the original matrix, and the second offset value indicates a second offset of a column, corresponding to an initial column (namely, a start column) of the first sub-block, in the original matrix relative to a start column (for example, a column 0) of the original matrix.
(2) A value of any element (for example, a first element) in the index matrix is equal to a difference between the first offset and a row index, in the original matrix, of an element that is in the first sub-block and that corresponds to the first element. A plurality of elements in the index matrix one-to-one correspond to the plurality of elements in the first sub-block.
(3) A value of any element (for example, a second element) in the index vector indicates a difference between the second offset and a column index, in the original matrix, of an element that is in the first sub-block and that corresponds to the second element. A plurality of elements in the index vector one-to-one correspond to all rows of the first sub-block.

According to the foregoing design, performing blocking on the original matrix can mainly optimize subscript data of an element, and split global subscript data of the original matrix into offset value pairs, index arrays, and index vectors of submatrices. A person skilled in the art may know that, when a scale of the original matrix is relatively large, an original global subscript data range is usually at high precision, for example, INT64 or INT32, and a data amount is also relatively large. After blocking is performed by using the method in embodiments of this application, a subscript data range of each submatrix becomes smaller, and the subscript range can be completely included by using only relatively low subscript precision, for example, INT16 or INT8. Only one offset value pair needs to be stored for each submatrix, and a data amount of subscript data that needs to be stored for all the submatrices can be greatly reduced.

In a possible implementation, the plurality of second sub-blocks include a plurality of third sub-blocks, and the plurality of third sub-blocks are obtained by performing blocking on the index matrix corresponding to each first sub-block by using a sub-block with a scale of M₂×N₂ as a unit.

In a possible implementation, the computing device stores a mapping relationship between the second sub-block and the third sub-block. In the mapping relationship, the plurality of second sub-blocks one-to-one correspond to the plurality of third sub-blocks. Specifically, one first sub-block is used as an example, in the mapping relationship, a plurality of second sub-blocks corresponding to the first sub-block one-to-one correspond to a plurality of third sub-blocks corresponding to an index matrix corresponding to the first sub-block.

A manner of storing the second sub-blocks is: The first sub-block is selected based on the row order or column order of the plurality of first sub-blocks, the second sub-blocks are used as storage modules, and the second sub-blocks are sequentially selected from the selected first sub-block in a row direction for storage. Elements in each second sub-block may be stored based on the row order or column order. Similarly, a manner of storing the third sub-blocks may be: The third sub-blocks are sequentially selected, from the index matrix corresponding to the selected first sub-block, for storage by using a third sub-block as a unit and in the row direction. Alternatively, all the second sub-blocks corresponding to the plurality of first sub-blocks are arranged based on the row order or column order, and the second sub-blocks are sequentially selected for storage based on the row order or column order for all the arranged second sub-blocks. Similarly, all the third sub-blocks corresponding to the plurality of first sub-blocks are arranged based on the row order or column order, and the third sub-blocks are sequentially selected for storage based on the row order or column order for all the arranged third sub-blocks.

The plurality of second sub-blocks and the plurality of third sub-blocks may be stored separately, or may be alternately stored. Separate storage means that the plurality of second sub-blocks are stored in first storage space, and the plurality of second sub-blocks are sequentially stored in the first storage space. For example, a storage order in the first storage space is: a second sub-block A, a second sub-block B, a second sub-block C, and the rest may be deduced by analogy. Similarly, the plurality of third sub-blocks are stored in second storage space, and the plurality of third sub-blocks are stored consecutively in the second storage space. For example, a storage order in the second storage space is: a third sub-block corresponding to the second sub-block A, a third sub-block corresponding to the second sub-block B, a third sub-block corresponding to the second sub-block C, and the rest may be deduced by analogy. In this way, when the plurality of second sub-blocks are sequentially read, the third sub-blocks corresponding to the plurality of second sub-blocks may also be sequentially read.

The alternate storage means that the second sub-block and the third sub-block are adjacently stored, that is, one second sub-block and a third sub-block corresponding to the second sub-block are used as a storage module. All the second sub-blocks and the third sub-blocks corresponding to the second sub-blocks are sequentially stored. For example, a storage order is: a second sub-block A, a third sub-block corresponding to the second sub-block A, a second sub-block B, a third sub-block corresponding to the second sub-block B, a second sub-block C, and the rest may be deduced by analogy. In this way, the second sub-block and the third sub-block corresponding to the second sub-block may be continuously read through one time of memory access.

Optionally, addresses of the plurality of second sub-blocks and/or the plurality of third sub-blocks that are sequentially stored are consecutive, so that data reading and prefetching are facilitated.

According to the foregoing design, data access of a plurality of consecutive second sub-blocks and/or third sub-blocks can be completed based on this storage manner through one time of data access. This facilitates the memory access, helps reduce the quantity of times of accessing the memory during the sparse matrix calculation, can adapt to the dedicated hardware accelerator with the high efficiency, and helps improve the degree of parallelism of the sparse matrix calculation.

In a possible implementation, each second sub-block stored in the computing device includes at least one non-zero element. In some cases, before the computing device sequentially stores values of the elements in each second sub-block, the method includes: removing a second sub-block whose elements are all zeros.

According to the foregoing design, the second sub-block whose elements are all zeros may be completely deleted without storage. In this way, the sparse matrix with random distribution can be adapted to, and the high compression rate can be maintained under any sparse matrix.

According to a second aspect, an embodiment of this application provides a matrix calculation apparatus. The apparatus has functions of implementing behavior of the computing device in any one of the first aspect and the possible implementation method examples of the first aspect. For beneficial effect, refer to descriptions of the first aspect. Details are not described herein again. The functions may be implemented by hardware, or may be implemented by hardware executing corresponding software. The hardware or software includes one or more modules corresponding to the foregoing functions. In a possible design, a structure of the apparatus includes an obtaining module, a processing module, and a storage module. These modules may have functions of performing behavior of the computing device in any one of the first aspect and the possible implementation method examples of the first aspect. For details, refer to the detailed descriptions in the method examples. Details are not described herein again.

According to a third aspect, an embodiment of this application provides a computing device. The computing device has functions of implementing behavior of the computing device in any one of the first aspect and the possible implementation method examples of the first aspect. For beneficial effect, refer to descriptions of the first aspect. Details are not described herein again. A structure of the computing device includes a processor and a storage. The processor is configured to support an apparatus to perform corresponding functions of the computing device in the method examples in the first aspect. The storage is coupled to the processor, and stores program instructions and data that are necessary for a communication apparatus. A structure of the communication apparatus further includes a communication interface, configured to communicate with another device.

According to a fourth aspect, this application further provides a computer-readable storage medium. The computer-readable storage medium stores instructions. When the instructions are run on a computer, the computer is enabled to perform the method in the first aspect and the possible implementations of the first aspect.

According to a fifth aspect, this application further provides a computer program product including instructions. When the computer program product runs on a computer, the computer is enabled to perform the method in the first aspect and the possible implementations of the first aspect.

According to a sixth aspect, this application further provides a computer chip. The chip is connected to a storage, and the chip is configured to read and execute a software program stored in the storage, to perform the method in the first aspect and the possible designs of the first aspect.

### BRIEF DESCRIPTION OF DRAWINGS

FIG. 1 to FIG. 7 are diagrams of sparse matrix data formats;

FIG. 8 is a diagram of a structure of a computing device according to an embodiment of this application;

FIG. 9 is a schematic flowchart corresponding to a matrix storage method according to an embodiment of this application;

FIG. 10 is a schematic flowchart of matrix blocking according to an embodiment of this application;

FIG. 11 is a schematic flowchart of compressing a submatrix according to an embodiment of this application;

FIG. 12 is a diagram of a submatrix and a corresponding element value array according to an embodiment of this application;

FIG. 13A and FIG. 13B are another schematic flowchart of compressing a submatrix according to an embodiment of this application;

FIG. 14 is a diagram of tiling according to an embodiment of this application;

FIG. 15 is a diagram of a tile storage manner according to an embodiment of this application;

FIG. 16 is a diagram of another tile storage manner according to an embodiment of this application; and

FIG. 17 is a diagram of a structure of a computing device according to an embodiment of this application.

### DESCRIPTION OF EMBODIMENTS

To better explain embodiments of this application, related terms or technologies in this application are first explained as follows:

### 1. Row Vector

The row vector is a 1×m matrix, where m is any positive integer, for example, x=[x₁, x₂, . . . , xₘ].

### 2. Column Vector

$$x = [ \begin{matrix}{x}_{1} \\ {x}_{2} \\ … \\ {x}_{n}\end{matrix} ] .$$

The column vector is an n×1 matrix, where n is any positive integer, for example,

### 3. Matrix Size/Scale

An m×n matrix is a rectangular array formed by arranging m rows and n columns of elements. For example:

$$A = [ \begin{matrix}{A}_{11} & {A}_{12} & … & {A}_{1 n} \\ {A}_{21} & {A}_{22} & … & {A}_{2 n} \\ … & … & … & … \\ {A}_{m 1} & {A}_{m 2} & … & {A}_{m n}\end{matrix} ] .$$

Each number forming the matrix is referred to as an element in the matrix. For example, A₁₁, A₁₂, . . . , and Aₘₙ are all elements in the matrix A. A subscript (or referred to as a coordinate) of an element indicates a location of the element in the matrix, and may be a row index (or referred to as a row coordinate) or a column index (or referred to as a column coordinate) of the element in the matrix. For example, a subscript “11” of A₁₁ indicates that the element is located in a row 1 and a column 1 of the matrix A, and A₂₁ indicates that the element is located in a row 2 and the column 1 of the matrix A. In addition, the subscript of the element may further have different representation forms, for example, A₁₁ may be written as A_{1,1}, or A₂₁ may be written as A_{2,1}. Similar parts are not described below.

It should be noted that a row index of a start row of a matrix is not limited to 1, and may alternatively be another value like 0. Similarly, a column index of a start column of the matrix is not limited to 1, and may alternatively be other data like 0. For example, if the row index of the start row and the column index of the start column of the matrix are: 0 and 0, a subscript of an initial element in the matrix is “00”, indicating that the element is in a row 0 and a column 0 of the matrix.

### 4. Matrix Addition

The matrix addition means adding two matrices with a same scale (or referred to as a same size, that is, the two matrices have a same quantity of rows and a same quantity of columns). For example, both A and B are m×n matrices, and matrix C=A+B:

$$A = [ \begin{matrix}{A}_{11} & {A}_{12} & … & {A}_{1 n} \\ {A}_{21} & {A}_{22} & … & {A}_{2 n} \\ … & … & … & … \\ {A}_{m 1} & {A}_{m 2} & … & {A}_{m n}\end{matrix} ] ; B = [ \begin{matrix}{B}_{11} & {B}_{12} & … & {B}_{1 n} \\ {B}_{21} & {B}_{22} & … & {B}_{2 n} \\ … & … & … & … \\ {B}_{m 1} & {B}_{m 2} & … & {B}_{m n}\end{matrix} ] ; and$$

$$C = A + B = [ \begin{matrix}{A}_{11} + {B}_{11} & {A}_{12} + {B}_{12} & … & {A}_{1 n} + {B}_{1 n} \\ {A}_{21} + {B}_{21} & {A}_{22} + {B}_{22} & … & {A}_{2 n} + {B}_{2 n} \\ … & … & … & … \\ {A}_{m 1} + {B}_{m 1} & {A}_{m 2} + {B}_{m 2} & … & {A}_{m n} + {B}_{mn}\end{matrix} ]$$

Similarly, matrix subtraction means subtracting elements at each same location in the two matrices with the same scale from each other.

### 5. Matrix Multiplication

For two matrices (for example, matrices D and E) to be multiplied, a quantity of columns of D needs to be the same as a quantity of rows of E. For example, if D is an m×n matrix and E is an n×p matrix, a product of D and E is an m×p matrix. For example:

$$D = [ \begin{matrix}{a}_{11} & {a}_{12} & {a}_{13} \\ {a}_{21} & {a}_{22} & {a}_{23}\end{matrix} ] ; E = ⌊ \begin{matrix}{b}_{11} & {b}_{12} \\ {b}_{21} & {b}_{22} \\ {b}_{31} & {b}_{32}\end{matrix} ⌋ ; and$$

$$F = DE = [ \begin{matrix}{a}_{11} {b}_{11} + {a}_{12} {b}_{21} + {a}_{13} {b}_{31} & {a}_{11} {b}_{12} + {a}_{12} {b}_{22} + {a}_{13} {b}_{32} \\ {a}_{21} {b}_{11} + {a}_{22} {b}_{21} + {a}_{23} {b}_{31} & {a}_{21} {b}_{12} + {a}_{22} {b}_{22} + {a}_{23} {b}_{32}\end{matrix} ]$$

### 6. Sparse Matrix/Dense Matrix

Matrices are classified into the sparse matrix and the dense matrix based on a proportion of non-zero elements in the matrix. The non-zero element means that a value of the element is not 0, and on the contrary, a zero element means that a value of the element is 0.

If most (for example, more than 50%) elements in a matrix are non-zero elements, the matrix is the dense matrix. On the contrary, if most elements in a matrix are zero, the matrix is the sparse matrix. A degree of sparsity is used to reflect a proportion of non-zero elements in the sparse matrix. A higher degree of sparsity indicates a lower proportion of non-zero elements. The following is an example of a sparse matrix:

| | | | | | | |
|---|---|---|---|---|---|---|
| 0 | 7 | 0 | 0 | 0 | 0 | 6 |
| 0 | 7 | 6 | 0 | 0 | 4 | 0 |
| 0 | 4 | 0 | 0 | 0 | 0 | 0 |
| 0 | 2 | 0 | 0 | 0 | 0 | 0 |
| 0 | 0 | 0 | 0 | 3 | 0 | 4 |

It may be understood that a large matrix needs a large amount of memory for storage, and values of most elements in the sparse matrix are zero. Therefore, when a computer stores and operates the sparse matrix, elements in the sparse matrix are usually encoded as sparse code, the sparse code usually includes only information (for example, a value and a subscript of the element) about a non-zero element, and memory costs of operating the sparse matrix are reduced by storing the sparse code of the non-zero element. In contrast, a matrix in an uncompressed format is usually referred to as the dense matrix, and the dense matrix includes only values of matrix elements, but does not store coordinates of the elements.

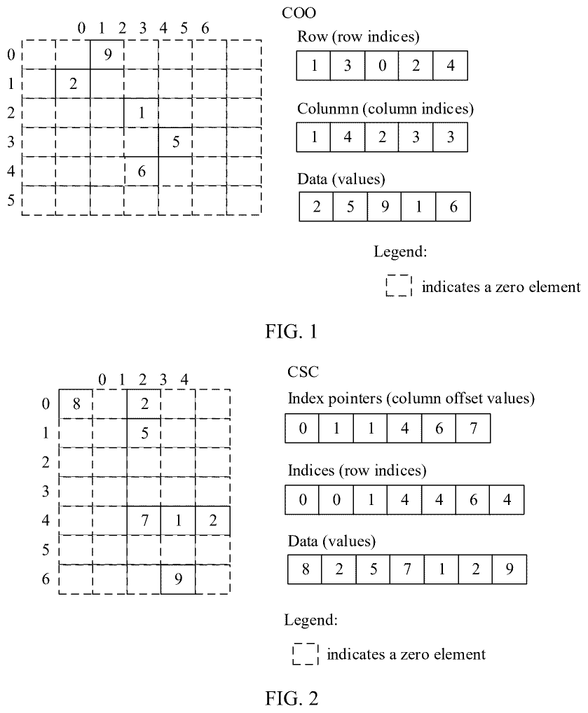

The following describes several common sparse code formats (which may also be referred to as sparse matrix data formats).
(1) Coordinate (COO) format: A triplet represents a matrix. The triplet includes three values: a row index, a column index, and an element value (data). The row index and the column index are used to identify a location of the element value in an original matrix. FIG. 1 shows a coordinate format corresponding to the sparse matrix by using a simple sparse matrix as an example. It should be noted that, for brevity, only non-zero elements are shown in the sparse matrix in FIG. 1, and other elements that are not shown are zero elements. Similarities are not described below.
(2) Compressed sparse column (CSC) format: Three types of data represent a sparse matrix. The three types of data are: a column offset value, a row index, and an element value. In comparison with the COO format, a difference is that in the CSC format, a column index is replaced with the column offset value. The column offset value indicates a start offset location, in value data, of a 1^{st} non-zero element in a column.

FIG. 2 shows an example of compression in the CSC format. The three types of data are described below.

As shown in FIG. 2, several intervals may be obtained based on an index pointer (011467): [0, 1), [1, 1), [1, 4), [4, 6), and [6, 7). These intervals correspond to elements in a column 0, a column 1, a column 2, a column 3, and a column 4 respectively. To be specific, [0, 1) corresponds to the column 0, [1, 1) corresponds to the column 1, [1, 4) corresponds to the column 2, and the rest may be deduced by analogy.

A 0^{th} row index, namely, 0, is selected from indices based on [0, 1). Because there is no valid range for [1, 1), a row index selected from indices based on [1, 1) is null. 1^{st} to 3^{rd} row indices, namely, 0, 1, and 4, are selected from indices based on [1, 4). 4^{th} and 5^{th} row indices, namely, 4 and 6, are selected from indices based on [4, 6). A 6^{th} row index, namely, 4, is selected from indices based on [6, 7).

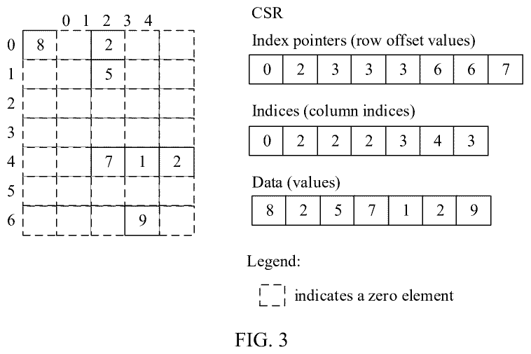

Based on the data, it may be determined that [0, 1) corresponds to an element 8 in the column 0 and a row 0. [1, 1) has no corresponding element, [1, 4) corresponds to an element 2 in the column 2 and the row 0, an element 5 in the column 2 and a row 1, and an element 7 in the column 2 and a row 4. [4, 6) corresponds to an element 1 in the column 3 and a row 4, and an element 9 in the column 3 and a row 6. [6, 7) corresponds to an element 2 in the column 4 and the row 4.
(3) Compressed sparse row (CSR) format: Three types of data represent a sparse matrix. The three types of data are: a row offset value, a column index, and an element value. In comparison with the COO format, a difference is that in the CSR format, a row index is replaced with the row offset value. The row offset value indicates a start offset location, in value data, of a 1^{st} non-zero element in a row. FIG. 3 shows an example of compression in the CSR format. Usage of the row offset value of the CSR format is similar to usage of the column offset value of the CSC format. Refer to the foregoing descriptions. Details are not described herein again.
(4) ELLPACK (ELL) format: Two matrices with same rows as an original matrix are used to store values and column indices separately. A matrix used to store the column indices may be referred to as a column index matrix, and a matrix used to store the values may be referred to as a value matrix. In the two matrices, if there is no element, a specified row length is obtained by padding zeros.

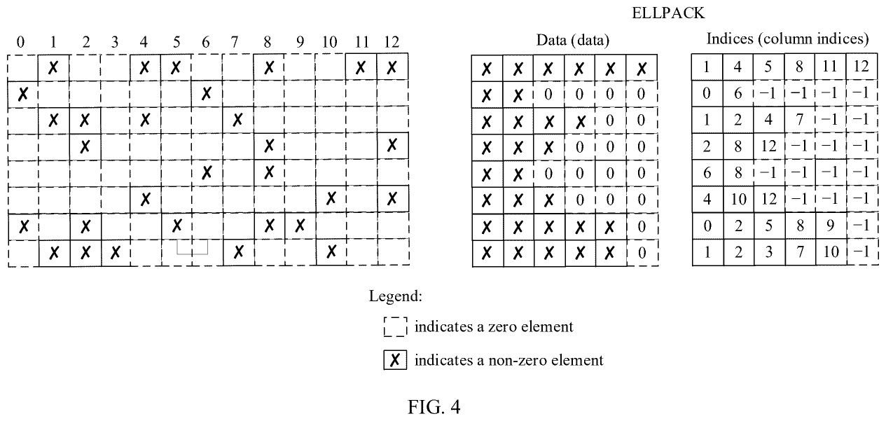

FIG. 4 shows an example of compression in the ELL format. It may be learned that if a row includes excessive attribute information, the column index matrix and the value matrix become abnormally “fat”, and there are a plurality of zero-padded elements at the end of other rows. This wastes storage space and affects a compression rate, and the compression rate may be low.
(5) Sliced ELLPACK (SELL) format: The SELL format is an extension of the ELL format. In the SELL format, an input matrix is divided into slices of adjacent rows, and rows of the slices are sorted based on a quantity of non-zero elements. Each slice is stored in the ELL format, a quantity of non-zero elements stored in the ELL format may vary with the slice, and each slice may have a different row length. In this way, a quantity of padded zeros in each slice can be reduced, thereby improving a compression rate of the format. In addition, in the SELL format, sorting is introduced to reduce storage overheads. Another variant is to limit a range of matrix sorting to a range of σ. In other words, in the format, matrix rows are sorted within σ consecutive rows rather than globally. This can further reduce an additional computation amount caused by sorting. Finally, each slice may be divided into arrays of a plurality of specifications for storage based on sorted element distribution, thereby further reducing the compression rate.

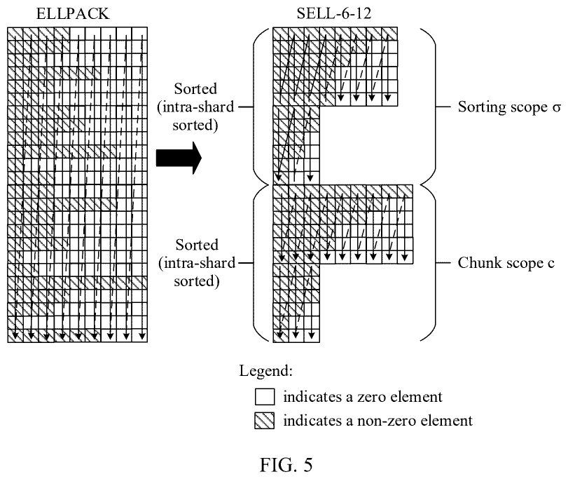

FIG. 5 shows an example of compression in the SELL format. As shown in FIG. 5, an original matrix is divided into two slices, sorting is performed within each slice in descending order of row lengths (measured by the quantity of non-zero elements), and data of each slice is stored in the ELL format. A 1^{st} slice includes an array of an 8×6 specification and an array of a 3×6 specification, and a 2^{nd} slice includes an array of a 9×6 specification and an array of a 3×6 specification.

Several sparse matrix data formats are described above. Currently, the sparse matrix data format is an important data type in the field of technologies such as artificial intelligence (AI), high-performance computing (HPC), graph) computing, and graph neural network (GNN) convolution computing. For example, compressed data is widely used in a plurality of matrix operation scenarios such as sparse matrix-vector (SpMV) multiplication, sparse matrix-sparse vector (SpMSpV) multiplication, sparse matrix-matrix (SpMM) multiplication, and sparse matrix-sparse matrix (SpGEMM, SpMSpM, or SpSpMM) multiplication.

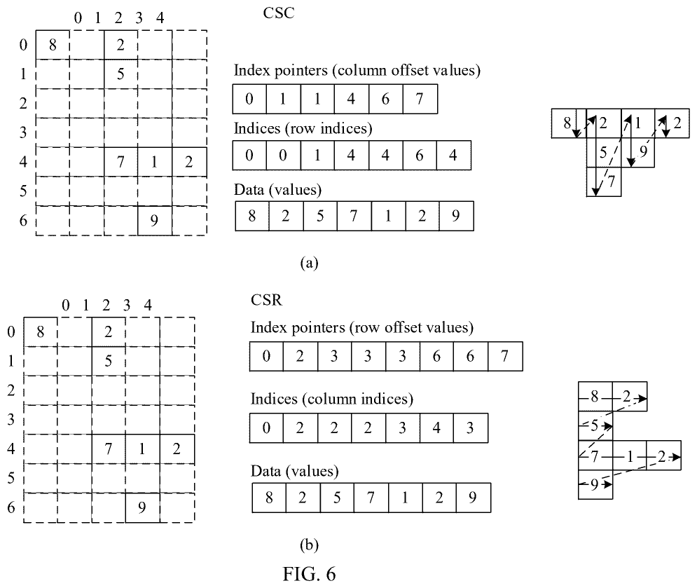

The compressed sparse column (CSC) format, the compressed sparse row (CSR) format, and the coordinate (COO) format are mainstream data formats. An idea of this type of data format is compressing non-zero elements in a row direction or column direction to store information like values and subscripts of non-zero elements. Specifically, as described above, in the CSC format and the CSR format, two independent arrays are used to store values of all non-zero elements in an original sparse matrix and indexes of rows or columns, and a 3^{rd} array is used to point to a pointer of a start location of each row or column of the arrays. In practice, a main disadvantage of the CSC format and the CSR format is that access to the value or the index of the sparse matrix has poor locality. The locality herein may be understood as that when accessing a storage (for example, a memory), whether a processor (for example, a CPU) accesses instructions or data, all accessed storage modules tend to gather in a small continuous area. For example, refer to (a) in FIG. 6. The CSC format has good locality for data storage and access in the column direction, but has poor locality for access in the row direction. Similarly, refer to (b) in FIG. 6. The CSR format has good locality for data storage and access in the row direction, but has poor locality for access in the column direction. In addition, row or column lengths of this type of format are inconsistent, and because only row vectors or column vectors of a fixed length can be accessed according to one vector instruction, it is difficult to access a plurality of vectors at a time during access. When the row or column lengths are inconsistent, the plurality of vectors cannot be accessed according to the vector instruction. This also makes it difficult to use a processor with a high degree of parallelism to accelerate matrix calculation.

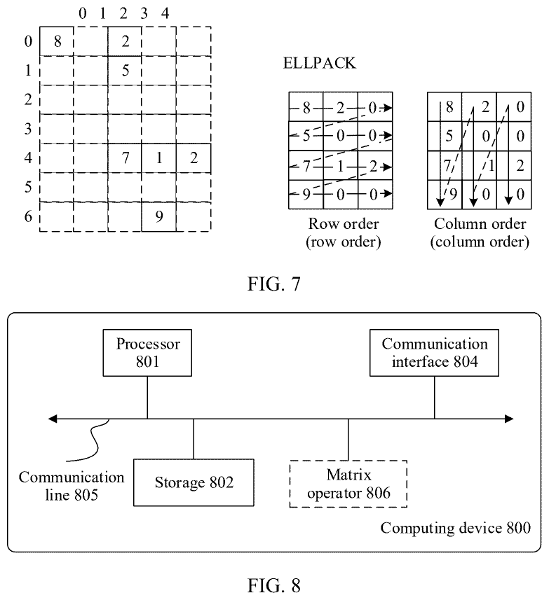

In recent years, the ELLPACK format has attracted much attention, and the ELLPACK format has been designed to improve execution efficiency of a vector processor. Refer to FIG. 7. In comparison with the compressed sparse row format, in the ELLPACK format, lengths of non-zero elements in each row are enabled to be consistent by using a zero-padding method. For a matrix A whose size is m×n and whose maximum row length (referring to a quantity of non-zero elements in the row) is k, an array whose size is m×k is required in the ELLPACK format to store the matrix A. A main disadvantage of the ELLPACK format is that if non-zero elements in an original sparse matrix are distributed irregularly, a length difference between compressed rows is large, and an array in the ELLPACK format has a large quantity of padded zeros. This results in a decrease in the compression rate, and computing efficiency of the vector processor decreases accordingly.

Therefore, some improved data formats like the sliced ELLPACK (SELL) format are derived based on the ELLPACK format. Return to FIG. 5 to understand that although the sliced ELLPACK format can further reduce the compression rate in comparison with the ELLPACK format, the sliced ELLPACK format and the ELLPACK format have a same problem: When non-zero elements in a shard (for example, a slice) are distributed irregularly, the compression rate is still low.

In conclusion, all existing sparse matrix compression formats have some disadvantages. Due to the disadvantages, an existing data format cannot meet a high concurrency requirement of a vector processor (or a matrix accelerator) in a new form, and consequently, development of the vector processor is limited. A data format that can meet data locality and a high compression rate is very important, and is also an important technology to drive sparse matrix calculation to accelerate chip development.

In view of this, this application provides a matrix storage method. The method is implemented based on a new sparse matrix data format provided in this application. The data format is applicable to a sparse matrix with any degree of sparsity and random distribution of non-zero elements, can be a solution to determining of the foregoing existing data format, and includes good locality and a high compression rate. In brief, in the method, execution by a computing device is used as an example. The computing device processes an original matrix based on the data format to obtain sparse code of the data format, and stores the sparse code of the data format by using an array of a fixed scale as a granularity. The storage manner can save storage overheads, and has the good data locality, the high compression rate, and a high degree of parallelism.

The following describes in detail the technical solutions provided in embodiments of this application with reference to the accompanying drawings.

FIG. 8 is a diagram of a computing device according to this application. The computing device 800 includes a processor 801 and a storage 802. Optionally, the device 800 may further include a communication interface 804 and a matrix operator 806. The processor 801, the storage 802, the matrix operator 806, and the communication interface 804 may be connected to each other through a communication line 805. The communication line 805 may be a peripheral component interconnect (PCI for short) bus, an extended industry standard architecture (EISA for short) bus, or the like. The communication line 805 may be classified into an address bus, a data bus, a control bus, and the like. For ease of representation, only one thick line is for representing the bus in FIG. 8, but this does not mean that there is only one bus or only one type of bus.

The processor 801 may be a central processing unit (CPU), an application-specific integrated circuit (ASIC), a field programmable gate array (FPGA), an artificial intelligence (AI) chip, a system on chip (SoC) or complex programmable logic device (CPLD), a graphics processing unit (GPU), a neural network processing unit (NPU), a microprocessor, or one or more integrated circuits configured to control program execution of the solutions of this application.

It should be noted that FIG. 8 shows only one processor 801. In actual application, there may be a plurality of processors 801. The plurality of processors 801 may include a plurality of processors of a same type, or may include a plurality of processors of different types. For example, the plurality of processors 801 include a plurality of CPUs. For another example, the plurality of processors 801 include at least one CPU, at least one GPU, and the like. One CPU further has one or more CPU cores. A quantity of processors 801, a quantity of CPU cores, and the like are not limited in embodiments.

Specifically, the processor 801 is configured to process a data access request from outside (for example, another computing device) of the computing device 800, and is also configured to process a request generated inside the computing device 800. For example, the request is a data write request, the data write request includes an original matrix, and the original matrix may be a sparse matrix. After receiving the data write request, the processor 801 may perform the matrix storage method provided in embodiments of this application, to process the original matrix, and store processed data in the storage 802. For another example, the request may alternatively be a data read request, the data read request is used to request to read matrix data, and the matrix data may include a part or all of an original matrix. After receiving the data read request, the processor 801 reads the matrix data from the storage 802.

In addition, the processor 801 is further configured to perform other data calculation or processing like matrix operations, specifically, for example, sparse matrix-vector (SpMV) multiplication, sparse matrix-sparse vector (SpMSpV) multiplication, sparse matrix-matrix (SpMM) multiplication, and sparse matrix-sparse matrix (SpGEMM, SpMSpM, or SpSpMM) multiplication. This is not specifically limited. Optionally, the foregoing matrix operations may alternatively be allocated to the matrix operator 806 for execution. In some cases, when the processor 801 has a plurality of cores, the computing device 800 includes the plurality of processors 801, or the computing device 800 includes a plurality of matrix operators 806, the plurality of cores, the plurality of processors 801, or the plurality of matrix operators 806 may perform the matrix operations in parallel. Details are not described herein.

The matrix operator 806 may be configured to process the matrix operation. Refer to the foregoing descriptions of the matrix operation. Details are not described herein again. The matrix operator 806 may include but is not limited to a vector processor (VP), a vector processor system (VPS), a matrix processor, a matrix accelerator, and the like. This is not specifically limited.

The communication interface 804 is configured to communicate, by using any apparatus like a transceiver, with another device or a communication network, for example, the Ethernet, a radio access network (RAN), a wireless local area network (WLAN), or a wired access network. For example, the communication interface 804 obtains the data read request, the data write request, and the matrix data.

The storage 802 is configured to store data and computer-executable program code. For example, the data includes but is not limited to data of the original matrix, sparse code of the sparse matrix, and the like. The executable program code may include program code of the matrix storage method provided in embodiments of this application, and the processor 801 executes the executable program code to implement the matrix storage method provided in embodiments. In other words, the storage 802 stores computer-executable instructions for executing the solutions of this application, and the processor 801 controls the execution. The processor 801 is configured to execute the computer-executable instructions stored in the storage 802, to implement the matrix storage method provided in the foregoing embodiments of this application.

For example, the storage 802 may further store a sparse matrix function library (sparse BLAS), and the function library may include but is not limited to one or more instructions provided in embodiments: a blocking instruction (for a function of the instruction, refer to the description in step 902, and details are not described herein again), a compression processing instruction (for a function of the instruction, refer to the description in step 903, and details are not described herein again), a zero-padding instruction, and a tiling instruction (for a function of the instruction, refer to the description in step 904, and details are not described herein again). The function library may further include another instruction, for example, an instruction for implementing an existing sparse matrix data format, for example, a compressed sparse column format instruction or an ELLPACK format instruction. The storage 802 may further store matrix operation instructions such as a load instruction, a sparse matrix-vector (SpMV) multiplication instruction, a sparse matrix-sparse vector (SpMSpV) multiplication instruction, a sparse matrix-matrix (SpMM) multiplication instruction, and a sparse matrix-sparse matrix (SpGEMM, SpMSpM, or SpSpMM) multiplication instruction. Optionally, the storage 802 may further store source code for implementing any instruction or function in the function library.

The storage 802 may exist independently, and is connected to the processor through the communication line 805. Alternatively, the storage 802 may be integrated with the processor. Specifically, for example, the storage 802 may include a memory, and may further include a hard disk. The memory is an internal storage that directly exchanges data with the processor 801. The memory can read and write data at a high speed at any time, and serves as a temporary data storage of an operating system or another running program. Different from the memory, the hard disk has a lower speed of reading and writing data than the memory, and is usually configured to store data persistently. In some application scenarios, the processor 801 may temporarily store data (for example, the sparse code of the sparse matrix) in the memory. When a total amount of data in the memory reaches a specific threshold, the processor 801 sends the data stored in the memory to the hard disk for persistent storage. The data may be obtained from an external device, input by a user, or generated by the computing device 800. This is not specifically limited. Alternatively, the processor 801 reads the data from the memory. When the memory is not hit, the processor 801 reads the data from the hard disk into the memory, and then reads the data from the memory.

The memory includes at least two types of memories. For example, the memory may be a random access memory, or may be a read-only memory (ROM). For example, the random access memory is a dynamic random access memory (DRAM) or a storage class memory (SCM). The memory may further include another random access memory, for example, a static random access memory (SRAM). For example, the read-only memory may be a programmable read-only memory (PROM) or an erasable programmable read-only memory (EPROM). In addition, the memory may alternatively be a dual in-line memory module (DIMM), that is, a module including the DRAM. In actual application, a plurality of memories and different types of memories may be configured in the computing device 800. A quantity and types of memories are not limited in embodiments.

The hard disk may be specifically a magnetic disk or another type of storage medium, for example, a solid-state drive (SSD), a hard disk drive (HDD), a shingled magnetic recording compact disc read-only memory (CD-ROM) or another compact disc storage, an optical disc storage (including a compact disc, a laser disc, an optical disc, a digital versatile disc, a Blu-ray disc, and the like), a magnetic disk storage medium or another magnetic storage device, or any other medium that can be configured to carry or store expected program code in a form of instructions or a data structure and that can be accessed by a computer. However, this is not limited thereto.

It should be noted that a structure of the computing device 800 shown in FIG. 8 is merely an example. In actual application, the computing device 800 may have more or fewer components. For example, the computing device 800 may further include input/output devices such as a keyboard, a mouse, and a display. This is not limited in embodiments of this application.

The following uses the computing device shown in FIG. 8 as an example to describe in detail a data format and a corresponding matrix storage method provided in embodiments of this application.

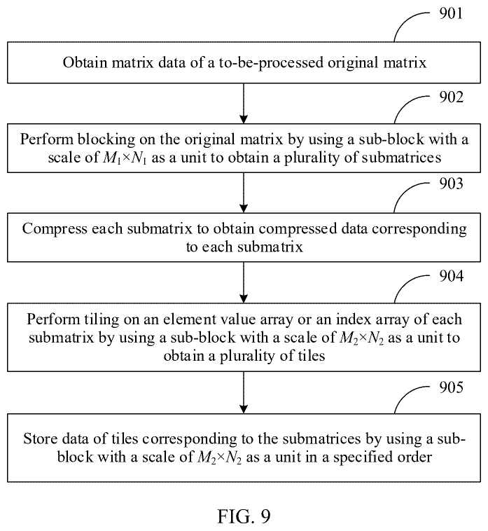

FIG. 9 is a schematic flowchart corresponding to a compressed storage method according to an embodiment of this application. The method may alternatively be performed by a computing device (for example, the computing device 800) having a data processing capability, or may be performed by a component, for example, the processor 801 or the matrix operator 806, of the computing device. For ease of description, the following uses the computing device 800 as an example for description. As shown in FIG. 9, the method includes the following steps.

Step 901: Obtain matrix data of a to-be-processed original matrix.

There are also a plurality of manners of obtaining the matrix data. In an obtaining manner, the processor 801 receives the matrix data input from the outside. For example, the matrix data may be input by a user to the computing device 800 via a terminal device, or may be directly input by the user to the computing device 800. Correspondingly, the computing device 800 (the processor 801) receives the matrix data directly or indirectly input by the user. In another obtaining manner, the processor 801 locally obtains the matrix data from the computing device 800. For example, the processor 801 obtains the matrix data from the storage 802.

The matrix data may be data of the original matrix. The original matrix may be a dense matrix, or may be a sparse matrix with any degree of sparsity. Alternatively, the matrix data may be sparse code of the sparse matrix, and a data format used for the sparse code may be any sparse matrix data format other than a data format provided in this application, for example, including but not limited to: a CSC format, a CSR format, a COO format, and an ELLPACK format. In conclusion, all sparse code that can be used to restore the original matrix and that is in any data format is applicable to embodiments of this application. Alternatively, the matrix data may be data obtained after further processing is performed on the sparse code. The further processing is processing like deduplication and compression. This is not specifically limited.

The foregoing is merely an example for description. In actual application, any type and obtaining manner of the matrix data are applicable to embodiments of this application.

Step 902: Perform blocking on the original matrix by using a sub-block with a scale of M₁×N₁ as a unit to obtain a plurality of submatrices.

An example in which the original matrix is the sparse matrix is used to describe step 902.

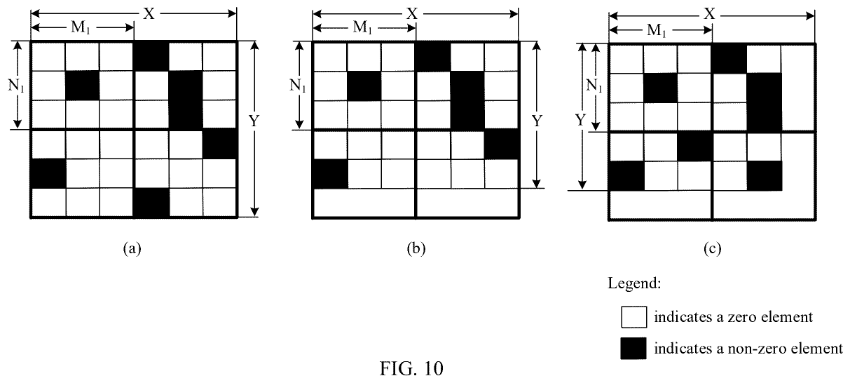

FIG. 10 is a diagram of performing blocking on a sparse matrix according to an embodiment. It is assumed that a scale of the sparse matrix is X×Y, and the scale of the sub-block is M₁×N₁. M₁ and N₁ are positive integers, and M₁×N₁ is less than X×Y. In a case, M₁ is a positive integer less than X, and N₁ is a positive integer not greater than Y; or M₁ is a positive integer not greater than X, and N₁ is a positive integer less than Y. Usually, M₁ is a positive integer less than X, N₁ is a positive integer less than Y, M₁ may be equal to N₁, and X may be equal to Y. For ease of description, it is assumed that in FIG. 10, M₁=N₁=3. At least one submatrix with a scale of 3×3 may be obtained by performing blocking on the sparse matrix by using a sub-block with a scale of 3×3, that is, the sparse matrix is divided into a plurality of submatrices with the scale of 3×3. The plurality of submatrices are sequentially adjacent to each other, and do not overlap each other. In addition, because X may not be an integer multiple of M₁, and/or Y may not be an integer multiple of N₁, scales of the plurality of submatrices may be completely the same, may be completely different, or may be partially the same.

As shown in (a) in FIG. 10, a sparse matrix A is cut into four submatrices by using a sub-block with a scale of 3×3, and scales of the four submatrices are the same, that is, 3×3. As shown in (b) in FIG. 10, a sparse matrix B is cut into four submatrices by using a sub-block with a scale of 3×3, and scales of the four submatrices are partially the same. Scales of the upper two submatrices are 3×3, and scales of the lower two submatrices are 3×2. As shown in (c) in FIG. 10, a sparse matrix C is cut into four submatrices by using a sub-block with a scale of 3×3, and scales of the four submatrices are completely different. The scales of the four submatrices are: 3×3, 2×3, 3×2, and 2×2. It should be noted that both the scale of the sparse matrix and the scale of the sub-block in FIG. 10 are examples. In actual application, the scale of the sparse matrix is usually large. This is not limited in this application.

Step 903: Perform compression processing on each submatrix to obtain compressed data corresponding to each submatrix.

One submatrix is used as an example. A compression processing procedure provided in this application may include: The processor 801 compresses non-zero elements in the submatrix in a specified direction (for example, a row direction or a column direction) to obtain the compressed data of the submatrix.

A compression processing manner provided in embodiments is described below based on two cases in which the specified direction is the row direction or the column direction. In the following, compression is performed in the row direction, which may also be referred to as row compression for short. Performing compression in the row direction and the row compression have a same meaning. Similarly, performing compression in the column direction may also be referred to as column compression for short.

### 1. The Specified Direction is the Row Direction.

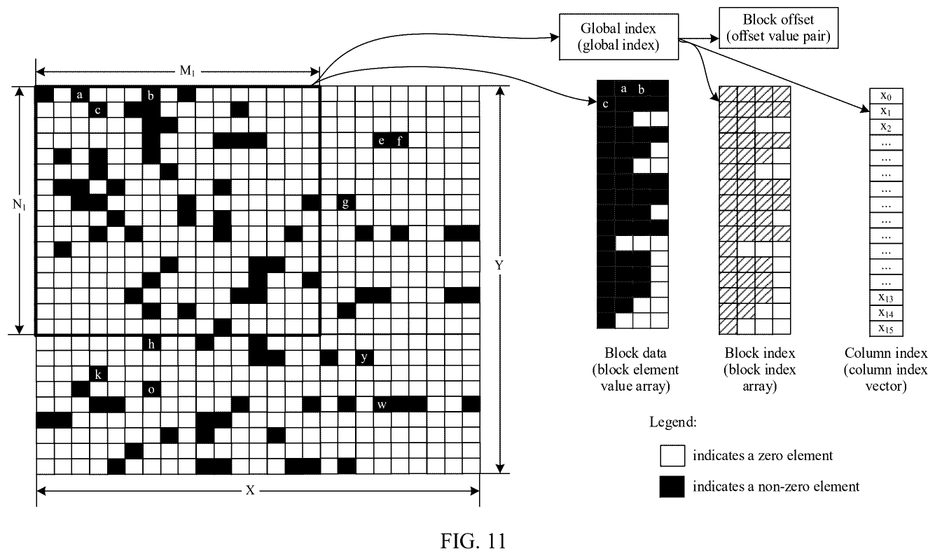

In FIG. 11, a sparse matrix is cut into four submatrices by using a sub-block with a scale of M₁×N₁, and the four submatrices are respectively denoted as a submatrix 1, a submatrix 2, a submatrix 3, and a submatrix 4 in a left-right and top-down order.

First, the submatrix 1 shown in FIG. 11 is used as an example. A specific procedure in which the processor 801 performs compression processing on the submatrix 1 may include the following steps.

Non-zero elements in the submatrix 1 are compressed in the row direction to generate compressed data of the submatrix 1. The compressed data of the submatrix includes an element value array (for example, block data) and subscript data of the submatrix 1.

(1) The element value array of the submatrix 1 includes the non-zero elements in the submatrix 1.

The element value array includes the non-zero elements arranged based on a row order in the submatrix 1, non-zero elements in a same row of the original matrix are still located in a same row in the element value array, and the non-zero elements in the element value array are arranged without gaps. A compression process of obtaining the element value array may include: compressing the non-zero elements in the submatrix 1 in the row direction (when there is a row whose elements are all zeros of the submatrix, the entire row whose elements are all zeros may be compressed), and performing zero padding based on a maximum row length obtained through compression to obtain the element value array (which may also be referred to as an element value matrix) corresponding to the submatrix 1. Optionally, zero padding may be further performed based on the maximum row length obtained after the submatrix 1 is compressed, to obtain element value array corresponding to the submatrix 1. In the element value array, lengths of all rows are consistent, and lengths of all columns are consistent. A compression process of an element value array of another submatrix is the same as this. Details are not described herein again.

(2) Subscript data (for example, a global index) of the submatrix 1 indicates a location (or a subscript, which may be referred to as an original location/or an original subscript for short below), in the original matrix, of each non-zero element in the element value array. The original subscript includes an original row index and an original column index. The original row index refers to a row index, in the original matrix, of the non-zero element in the element value array, and the original column index refers to a column index, in the original matrix, of the non-zero element in the element value array. For example, in FIG. 11, an original subscript, in the original matrix, of an element in a row 0 and a column 0 in the element value array is (0, 0). For another example, an original subscript, in the original matrix, of an element in the row 0 and a column 1 in the element value array is (0, 2). For still another example, an original subscript, in the original matrix, of an element in the row 0 and a column 2 in the element value array is (0, 6).

The subscript data of the submatrix 1 includes an offset value pair, an index array (or referred to as an index matrix), and an index vector of the submatrix 1.

(1) First, the offset value pair is described.

The subscript data of the submatrix 1 includes the offset value pair (for example, a block offset) of the submatrix. The so-called offset value pair includes a row offset and a column offset. The row offset refers to an offset between a start row of the original matrix and a start row of the submatrix in the original matrix, and the column offset refers to an offset between a start column of the original matrix and a start column of the submatrix in the original matrix.

With reference to FIG. 11, it is assumed that a scale of a sub-block is M₁×N₁=16×16. A start row index and a start column index of the original matrix are both 0. The original row index of the start row and the original column index of the start column of the submatrix 1 are (0, 0), an original row index of a start row and an original column index of a start column of the submatrix 2 are (0, 16), an original row index of a start row and an original column index of a start column of the submatrix 3 are (16, 0), and an original row index of a start row and an original column index of a start column of the submatrix 4 are (16, 16).

Based on this, the row offset of the submatrix 1=the original row index of the start row of the submatrix 1−the row index of the start row of the original matrix=0−0=0, and the column offset of the submatrix 1=the original column index of the start column of the submatrix 1−the column index of the start column of the original matrix=0. That is, the offset value pair of the submatrix 1 is (0, 0).

A row offset of the submatrix 2=the original row index of the start row of the submatrix 2−the row index of the start row of the original matrix=0−0=0, and a column offset of the submatrix 2−the original column index of the start column of the submatrix 2−the column index of the start column of the original matrix=16−0=16. That is, an offset value pair of the submatrix 2 is (0, 16).

A row offset of the submatrix 3=the original row index of the start row of the submatrix 3−the row index of the start row of the original matrix=16−0=16, and a column offset of the submatrix 3=the original column index of the start column of the submatrix 3−the column index of the start column of the original matrix=0−0=0. That is, an offset value pair of the submatrix 3 is (16, 0).

A row offset of the submatrix 4−the original row index of the start row of the submatrix 4−the row index of the start row of the original matrix=16−0=16, and a column offset of the submatrix 4=the original column index of the start column of the submatrix 4−the column index of the start column of the original matrix=16−0=16. That is, an offset value pair of the submatrix 4 is (16, 16).

(2) The index array and the index vector are described below.

When specified directions are different, elements in the index array and elements in the index vector represent different meanings. The following continues to specify a direction as the row direction, and describes index data and the index vector of the submatrix 1.

A value of an element in the index array of the submatrix 1 and the column offset of the submatrix 1 indicate an original column index of a corresponding element in the element value array of the submatrix 1. Specifically, for example, in a formula 1, an original column index of any element (denoted as a first element) in the element value array of the submatrix 1=the column offset of the submatrix 1+a value of an element (denoted as a second element) that is in the index array of the submatrix 1 and that corresponds to the first element. In brief, the original column index of the non-zero element=the column offset+the value of the corresponding element in the index array.

Elements included in the index array of the submatrix 1 one-to-one correspond to elements included in the element value array of the submatrix 1. The one-to-one correspondence means that two elements at same locations in the index array and the element value array are in a one-to-one correspondence. In other words, an element (for example, the first element) at a location (i, j) in the index array corresponds to an element (for example, the second element) at a location (i, j) in the element value array. For example, an element at a location (0, 0) in the index array corresponds to an element at a location (0, 0) in the element value array, an element at a location (0, 1) in the index array corresponds to an element at a location (0, 1) in the element value array, an element at a location (16, 4) in the index array corresponds to an element at a location (16, 4) in the element value array, and the rest may be deduced by analogy.

It may be learned according to the formula 1: a value of the any element in the index array of the submatrix 1=an original column index of an element at a corresponding location in the element value array of the submatrix 1−the column offset of the submatrix 1. For example, still refer to FIG. 11. For example, an original column index of the element (for example, an element identified by “a” in FIG. 11) at the location (0, 1) in the element value array of the submatrix 1 is 2, and because the column offset of the submatrix 1 is 0, a value of the element at the location (0, 1) in the index array of the submatrix 1=2−0=2. For another example, an original column index of an element (for example, an element identified by “b” in FIG. 11) at a location (0, 2) in the element value array of the submatrix 1 is 6, and because the column offset of the submatrix 1 is 0, a value of an element at a location (0, 2) in the index array of the submatrix 1=6−0=6. For still another example, an original column index of an element (for example, an element identified by “c” in FIG. 11) at a location (1, 0) in the element value array of the submatrix 1 is 3, and because the column offset of the submatrix 1 is 0, a value of an element at a location (1, 0) in the index array of the submatrix 1=3−0=3.

A value of an element in the index vector of the submatrix 1 and the row offset of the submatrix 1 indicate an original row index of a corresponding element in the element value array of the submatrix 1. Specifically, for example, in a formula 2, an original row index of any element (denoted as a first element) in the element value array of the submatrix 1=the row offset of the submatrix 1+a value of an element (for example, a second element) that is in the index vector of the submatrix 1 and that corresponds to the first element. In brief, the original row index of the non-zero element=the row offset+the value of the corresponding element in the index vector.

Elements included in the index vector one-to-one correspond to a plurality of rows included in the element value array. For example, a 0^{th} element in the index vector corresponds to the row 0 in the element value array, a 1^{st} element in the index vector corresponds to a row 1 in the element value array, an i^{th} element in the index vector corresponds to a row i in the element value array, and the rest may be deduced by analogy. In other words, an element in the row i in the element value array corresponds to the i^{th} element in the index vector.

It may be learned according to the formula 2: a value of the any element in the index vector of the submatrix 1=an original row index of an element in a corresponding row in the element value array of the submatrix 1−the row offset of the submatrix 1. The index vector may be a 1×n matrix, or may be an n×1 matrix. It is assumed that the index vector of the submatrix 1 is x=[x₀, x₁, . . . , xₙ₋₁]. Still refer to FIG. 11. For example, original row indices of elements in the row 0 in the element value array of the submatrix 1 are all 0, and because the row offset of the submatrix 1 is 0, a value of the 0^{th} element (for example, x₀) in the index vector of the submatrix 1=0−0=0. For another example, original row indices of elements in the row 1 in the element value array of the submatrix 1 are all 1, and because the row offset of the submatrix 1 is 0, a value of an element (for example, x₁) in a row 1 in the index vector of the submatrix 1=1−0=1. For still another example, original row indices of elements in a row 15 in the element value array of the submatrix 1 are all 15, and because the row offset of the submatrix 1 is 0, a value of an element (for example, x₁₅) in a row 15 in the index vector of the submatrix 1=15−0=15. That is, index vectors of the submatrix 1 are [0, 1, 2, 3, . . . , 14, 15]. It may be understood that when the submatrix 1 does not include a row whose elements are all zeros, the value of the element in the index vector of the submatrix 1 is the original row index of the element in the corresponding row in the element value array.

The foregoing describes a procedure of determining the compressed data of the submatrix 1. The following continues to briefly describe an example of determining compressed data of another submatrix.

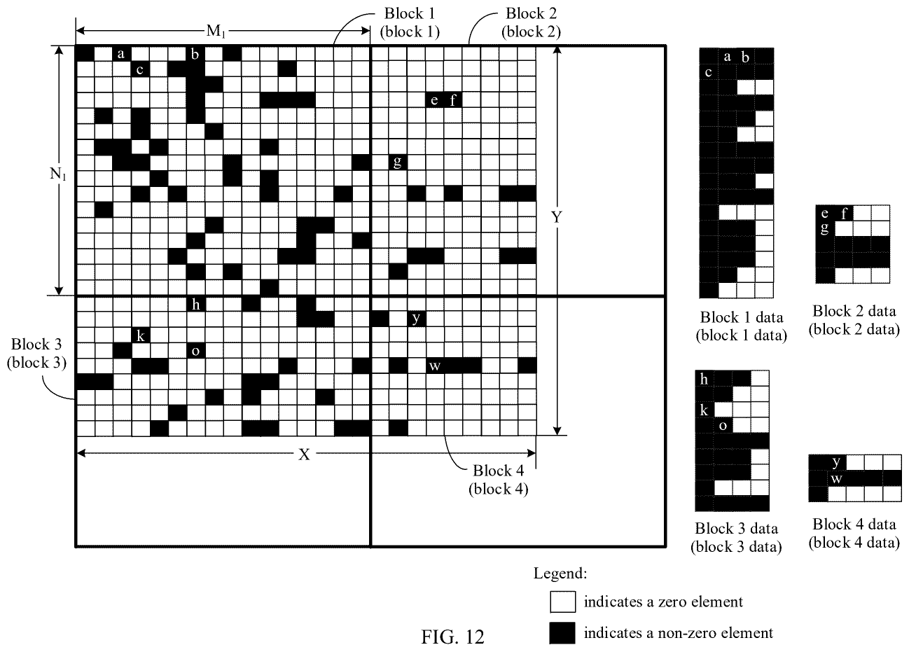

As described above, the offset value pair of the submatrix 2 is (0, 16). With reference to FIG. 11 and FIG. 12, it is understood that, for example, an original subscript of an element (for example, an element identified by “e” in FIG. 11) at a location (0, 0) in an element value array of the submatrix 2 is (3, 19), and a value of an element at a location (0, 0) in an index array of the submatrix 2=19−16=3.

For another example, an original subscript of an element (for example, an element identified by “f” in FIG. 12) at a location (0, 1) in the element value array of the submatrix 2 is (3, 20), and a value of an element at a location (0, 1) in the index array of the submatrix Feb. 20, 2016=4. Values of 0^{th} elements (corresponding to elements, for example, e and f, in a row 0 in the element value array) in the index vector of the submatrix 2=3−0=3.

For still another example, an original subscript of an element (for example, an element identified by “g” in FIG. 12) at a location (1, 0) in the element value array of the submatrix 2 is (7, 17), and a value of an element at a location (1, 0) in the index array of the submatrix 2=17−16=1. A value of a 1^{st} element (corresponding to an element, for example, g, in a row 1 in the element value array) in the index vector of the submatrix 2=7−0=7.

The rest may be deduced by analogy. The index array and the index vector of the submatrix 2 are determined.

As described above, the offset value pair of the submatrix 3 is (16, 0). With reference to FIG. 11 and FIG. 12, it is understood that, for example, an original subscript of an element (for example, an element identified by “h” in FIG. 12) at a location (0, 0) in an element value array of the submatrix 3 is (16, 6), and a value of an element at a location (0, 0) in an index array of the submatrix 3=6−0=6. A value of a 0^{th} element (corresponding to an element, for example, h, in a row 0 in the element value array) in the index vector of the submatrix 3=16−16=0.

For another example, an original subscript of an element (for example, an element identified by “k” in FIG. 12) at a location (2, 0) in the element value array of the submatrix 3 is (18, 3), and a value of an element at a location (2, 0) in the index array of the submatrix 3=3−0=3. A value of a 2^{nd} element (corresponding to an element, for example, k, in a row 2 in the element value array) in the index vector of the submatrix 3=18−16=2.

For still another example, an original subscript of an element (for example, an element identified by “o” in FIG. 12) at a location (3, 1) in the element value array of the submatrix 3 is (19, 6), and a value of an element at a location (3, 1) in the index array of the submatrix 3=6−0=6. A value of a 3^{rd} element (corresponding to an element, for example, o, in a row 3 in the element value array) in the index vector of the submatrix 3=19−16=3.

The rest may be deduced by analogy. The index array and the index vector of the submatrix 3 are determined.

As described above, the offset value pair of the submatrix 4 is (16, 16). With reference to FIG. 11 and FIG. 12, it is understood that, for example, an original subscript of an element (for example, an element identified by “y” in FIG. 12) at a location (0, 1) in an element value array of the submatrix 4 is (17, 18), and a value of an element at a location (0, 1) in an index array of the submatrix 4=18−16=2. A value of a 0^{th} element (corresponding to an element, for example, y, in a row 0 in the element value array) in the index vector of the submatrix 4=17−16=1.

For another example, an original subscript of an element (for example, an element identified by “w” in FIG. 12) at a location (1, 1) in the element value array of the submatrix 4 is (20, 19), and a value of an element at a location (1, 1) in the index array of the submatrix 4=19−16−3. A value of a 1^{st} element (corresponding to an element, for example, w, in a row 1 in the element value array) in the index vector of the submatrix Apr. 20, 2016=4.

The rest may be deduced by analogy. The index array and the index vector of the submatrix 4 are determined.

It can be learned from the foregoing design that performing blocking on the original matrix can mainly optimize subscript data of an element, and split global subscript data of the original matrix into offset value pairs, index arrays, and index vectors of submatrices. A person skilled in the art may know that, when a scale of the original matrix is relatively large, an original global subscript data range is usually at high precision, for example, INT64 or INT32, and a data amount is also relatively large. After blocking is performed by using the method in embodiments of this application, a subscript data range of each submatrix becomes smaller, and the subscript range can be completely included by using only relatively low subscript precision, for example, INT16 or INT8. Only one offset value pair needs to be stored for each submatrix, and a data amount of subscript data that needs to be stored for all the submatrices can be greatly reduced.

The foregoing describes a process of performing compression in the row direction to obtain compressed data of the submatrices. The following describes a process of performing compression in the column direction to obtain compressed data of the submatrices.

### 2. The Specified Direction is the Column Direction.

It should be noted that regardless of whether a compression direction is the row direction or the column direction, the offset value pairs of the submatrices are not affected, that is, the determined offset value pairs of the submatrices are the same. Refer to the foregoing manner of determining the offset value pairs of the submatrices. Details are not described herein again. The following describes only differences.

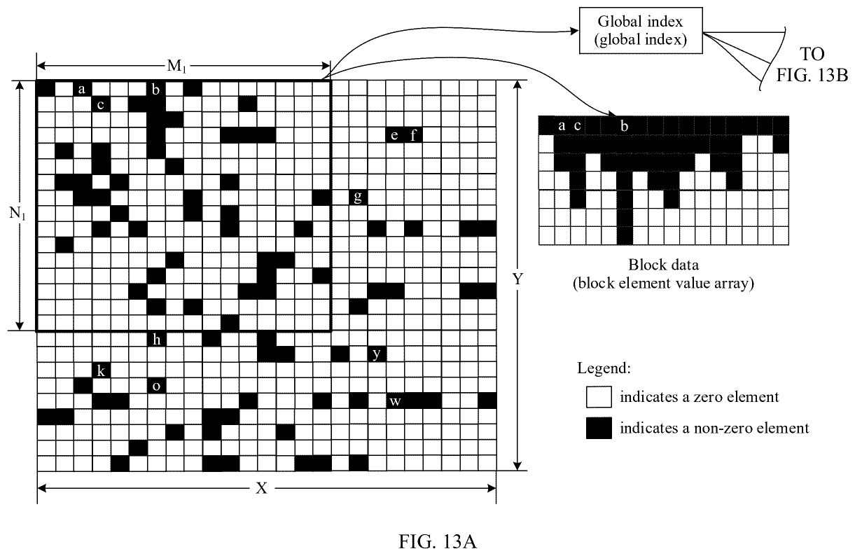

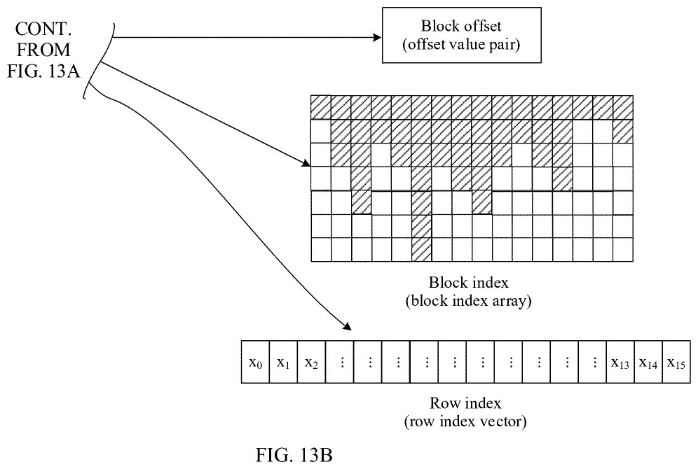

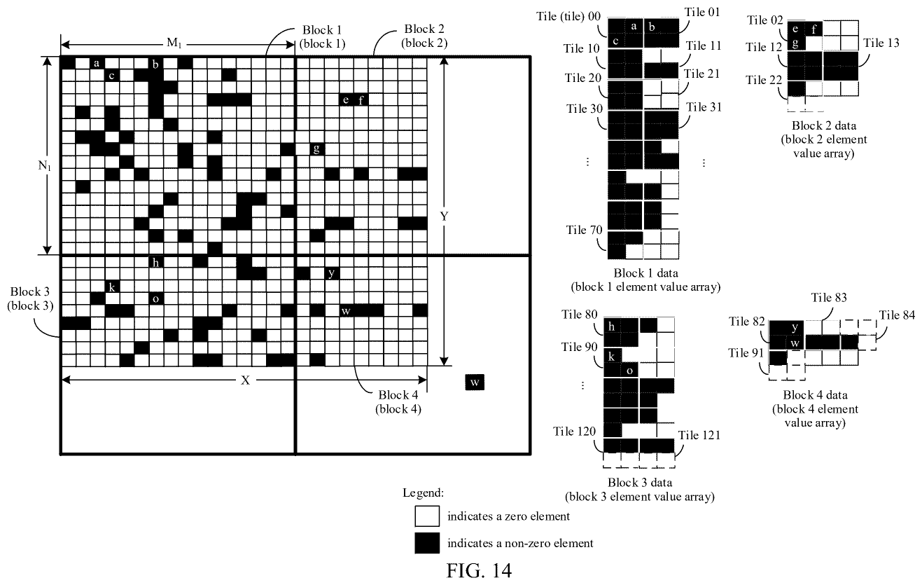

FIG. 13A and FIG. 13B are a diagram of compressing a submatrix in the column direction according to an embodiment. The submatrix 1 shown in FIG. 13A and FIG. 13B is used as an example, the submatrix 1 is compressed in the column direction to obtain the compressed data of the submatrix 1. The compressed data of the submatrix 1 includes the element value array and the subscript data of the submatrix 1.

The element value array of the submatrix 1 includes non-zero elements arranged based on a column order in the submatrix 1, non-zero elements in a same column of the original matrix are still located in a same column in the element value array, and there are no gaps between the non-zero elements in the element value array. A compression process of obtaining the element value array may include: compressing the non-zero elements in the submatrix 1 in the column direction (when there is a column whose elements are all zeros of the submatrix, the entire column whose elements are all zeros may be compressed), and performing zero padding based on a maximum column length obtained through compression to obtain the element value array corresponding to the submatrix. A compression process of an element value array of another submatrix is the same as this. Details are not described herein again.

The subscript data of the submatrix 1 includes an offset value pair, an index array, and an index vector of the submatrix 1.

A value of an element in the index array of the submatrix 1 and the row offset of the submatrix 1 indicate an original row index of a corresponding element in the element value array of the submatrix 1. Specifically, for example, in a formula 3, an original row index of any element (denoted as a first element) in the element value array of the submatrix 1=the row offset of the submatrix 1+a value of an element (denoted as a second element) that is in the index array of the submatrix 1 and that corresponds to the first element. In brief, the original row index of the non-zero element=the row offset+the value of the corresponding element in the index array.

It may be learned according to the formula 3: a value of the any element in the index array of the submatrix 1=an original row index of an element at a corresponding location in the element value array of the submatrix 1−the row offset of the submatrix 1. For example, refer to FIG. 13A and FIG. 13B. For example, an original row index of an element at a location (0, 1) in the element value array of the submatrix 1 is 4, the row offset of the submatrix 1 is 0, and a value of an element at a location (0, 1) in the index array of the submatrix 1=4−0=4. For another example, an original row index of an element at a location (3, 2) in the element value array of the submatrix 1 is 7, the row offset of the submatrix 1 is 0, and a value of an element at a location (3, 2) in the index array of the submatrix 1=7−0=7. For still another example, an original row index of an element at a location (5, 5) in the element value array of the submatrix 1 is 12, the row offset of the submatrix 1 is 0, and a value of an element at a location (5, 5) in the index array of the submatrix 1=12−0=12. The rest may be deduced by analogy.

A value of an element in the index vector of the submatrix 1 and the column offset of the submatrix 1 indicate an original column index of a corresponding element in the element value array of the submatrix 1. Specifically, for example, in a formula 4, an original column index of any element (denoted as a first element) in the element value array of the submatrix 1−the column offset of the submatrix 1+a value of an element (for example, a second element) that is in the index vector of the submatrix 1 and that corresponds to the first element. In brief, the original column index of the non-zero element=the column offset+the value of the corresponding element in the index vector.

It may be learned according to the formula 4: a value of the any element in the index vector of the submatrix 1=an original column index of an element in a corresponding column in the element value array of the submatrix 1−the column offset of the submatrix 1. The index vector may be a 1×m matrix, or may be an m×1 matrix. For example, refer to FIG. 13A and FIG. 13B. It is assumed that the index vector of the submatrix 1 is the 1×m matrix, for example, y=[y₀, y₁, . . . , yₘ₋₁], and m=a quantity of columns of the element value array of the submatrix. For example, original column indices of elements in a column 0 in the element value array of the submatrix 1 are all 0, the column offset of the submatrix 1 is 0, and a value of an element (for example, y₀) in the column 0 in the index vector of the submatrix 1 is 0−0=0. For another example, original column indices of elements in a column 1 in the element value array of the submatrix 1 are all 1, and a value of an element (for example, y₁) in the column 1 in the index vector of the submatrix 1 is 1−0=1. The rest may be deduced by analogy. When the submatrix 1 does not include a column whose elements are all zeros, the value of the element in the index vector of the submatrix 1 is the original column index of the element in the corresponding row in the element value array.

The foregoing describes compression manners in the two compression directions. In this application, the row compression or the column compression is not limited for each matrix. In actual application, whether to use the row compression or the column compression may be determined based on a requirement of a matrix multiplication operation. For example, the row compression may be used to store a left matrix (which refers to one of two matrices to be multiplied in SpGEMM) of the sparse matrix-sparse matrix (SpGEMM) multiplication, and the column compression may be used to store a right matrix (the other matrix of the two matrices to be multiplied in the SpGEMM), to achieve good locality. This is also suitable for use of a GPU and vector processor architecture.

It should be noted that, in this application, different submatrices of the original matrix may alternatively be compressed in different directions. However, to improve processing efficiency, in step 903, compression manners of all the submatrices may be the same. For example, if the row direction is used, the submatrices of the original matrix are all compressed in the row direction. If the column direction is used, the submatrices of the original matrix are all compressed in the column direction.

In addition, it should be noted that step 901 to step 903 are optional steps, and are not mandatory steps. For example, the computing device 800 may further obtain, from another device, compressed data corresponding to the submatrices.

Step 904: Separately perform tiling on an array (like an element value array or an index array) in compressed data of each submatrix by using a sub-block with a scale of M₂×N₂ as a unit to obtain a plurality of tiles corresponding to each submatrix.

One submatrix is used as an example. A process of performing tiling on compressed data of the submatrix may include: performing tiling on an element value array of the submatrix by using a sub-block with a scale of M₂×N₂ as a unit to obtain a plurality of tiles (denoted as second sub-blocks); and performing tiling on an index array of the submatrix by using a sub-block with a scale of M₂×N₂ as a unit to obtain a plurality of tiles (denoted as third sub-blocks). M₂ is a positive integer not greater than M₁, N₂ is a positive integer not greater than N₁, and M₂×N₂ is less than M₁×N₁. In a case, M₂ is a positive integer less than M₁, and N₂ is a positive integer not greater than N₁; or M₂ is a positive integer not greater than M₁, and N₂ is a positive integer less than N₁. That is, the scale of the sub-block is usually less than a scale of the element value array or a scale of the index array.

The element value array shown in FIG. 12 is used as an example. FIG. 14 is a diagram of performing tiling on element value arrays of submatrices according to an embodiment of this application. In FIG. 14, the scale of the sub-block is M₂×N₂=2×2. As shown in FIG. 14, the processor 801 may perform, in the row direction, tiling on the element value arrays by using a sub-block with a scale of 2×2. In this way, each element value array is cut into a plurality of tiles, and all the tiles have a same size (for example, scales are all 2×2 in FIG. 14) and do not overlap each other. Optionally, when a quantity of elements at the end of the row direction or the column direction of the element value array is less than 2×2, zero padding is performed to obtain the scale of 2×2. For example, refer to the bottom of an element value array of a block 2 in FIG. 14. A tile 22 is a small block obtained through zero-padding, and elements padded with zeros in the tile are shown by dashed boxes.

Similarly, the processor 801 performs tiling on the index array of the submatrix by using a sub-block with a scale of M₂×N₂ as a unit to obtain a plurality of tiles of the index array. All the tiles have a same size and do not overlap each other. For effect of performing tiling on the index array, refer to effect of performing tiling on the element value array of the submatrix shown in FIG. 14. Details are not described herein again.

It should be understood that the sub-block with a scale of 2×2 as a unit shown in FIG. 14 is merely an example for description. The scale of the sub-block used to perform tiling is not limited in embodiments of this application. An embodiment further provides a manner of determining a scale of a sub-block. For example, the scale of the sub-block may be determined based on a data bit width of a matrix operator like a vector processor or a matrix accelerator. For example, a length of the vector processor is 2, and tiling may be performed by using a sub-block with a scale of 2×2 as a unit. For another example, a length of the vector processor is 4, and tiling may be performed by using a sub-block with a scale of 4×4 as a unit, to adapt to the data bit width of the matrix operator. Herein, only an example of determining the scale of the sub-block is provided. In embodiments, the scale of the sub-block in this step may alternatively be determined in another manner. This is not specifically limited.

It should be noted that both the element value array and the index array shown in FIG. 11 to FIG. 14 are shown by using an example in which the compression processing includes the zero padding. The compression processing in embodiments of this application may alternatively not include the zero padding. For example, the element value array and the index array do not include the zero element. For example, the zero elements in the element value array and the index array in FIG. 11 to FIG. 15 are removed, and then zero padding is performed on tiles when tiling is performed on the element value array and the index array from which the zero elements are removed.

Step 905: Store data of tiles corresponding to the submatrices by using a sub-block with a scale of M₂×N₂ as a unit in a specified order.

Specifically, step 905 includes storing the element value arrays and the subscript data of the submatrices. When the element value arrays and the index arrays are stored, the M₂×N₂ sub-block is used as the storage unit, the data of the tiles corresponding to the stored element value arrays and index arrays is stored based on the specified order.

An embodiment provides a plurality of manners of storing the tiles.

### Storage Manner 1:

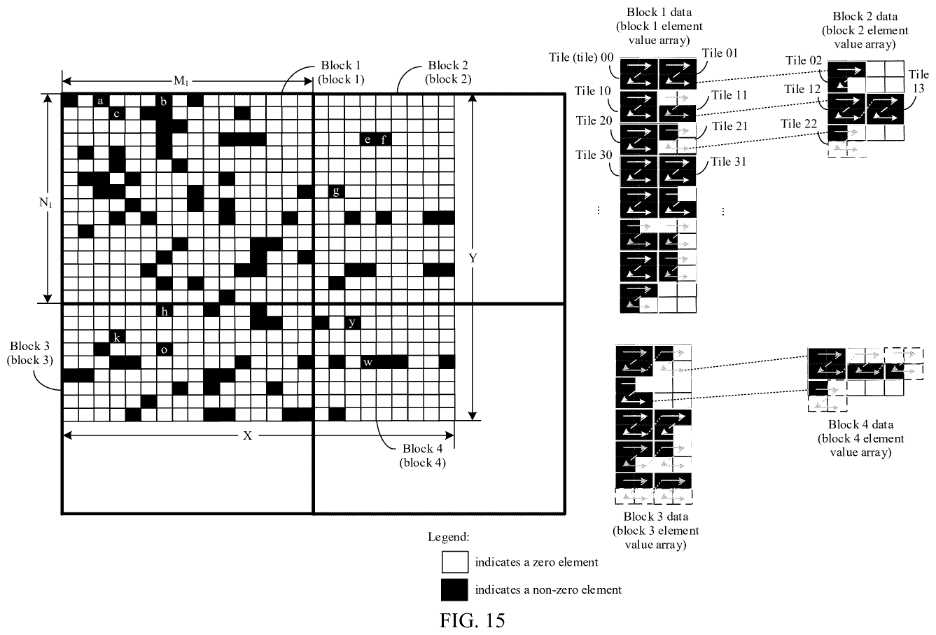

The element value array shown in FIG. 14 is used as an example. In an embodiment, the tiles may be selected based on the row order. For example, in an implementation, for tiles included in a plurality of element value arrays belonging to a same sparse matrix, sub-blocks are selected based on the row order of the tiles. Optionally, a tile whose elements are all zeros may be removed, that is, the tile whose elements are all zeros is not stored. Details are not described below again. As shown in FIG. 15, a selection order of the tiles may be: a tile 00, a tile 01, a tile 02, a tile 10, a tile 11, a tile 12, a tile 13, a tile 20, a tile 21, a tile 22, a tile 30, a tile 31, a tile 40, . . . , a tile 70, a tile 80, a tile 81, a tile 82, a tile 90, a tile 91, . . . , and a tile 121.

For each selected tile, data of each tile is sequentially stored. For example, based on the foregoing selection order of the tiles, for the tile 00, an element (0, 0), an element (0, 1), an element (1, 0), and an element (1, 1) of the tile 00 are sequentially stored; an element (0, 0), an element (0, 1), an element (1, 0), and an element (1, 1) of the tile 01 are sequentially stored; an element (0, 0), an element (0, 1), an element (1, 0), and an element (1, 1) of the tile 02 are sequentially stored; an element (0, 0), an element (0, 1), an element (1, 0), and an element (1, 1) of the tile 10 are sequentially stored; and the rest may be deduced by analogy.

In another implementation, a submatrix is used as an object, and tiles corresponding to submatrices are sequentially stored based on the row order. For example, with reference to FIG. 15, tiles corresponding to the submatrix 1 are stored, tiles corresponding to the submatrix 2 are stored, tiles corresponding to the submatrix 3 are stored, and tiles corresponding to the submatrix 4 are stored. The tiles in the submatrices may be sequentially stored or stored in parallel. In general, the tiles in each submatrix are stored consecutively. The plurality of tiles corresponding to each submatrix may be selected based on the row order. Specifically, with reference to FIG. 15, a selection order of the tiles may be: a tile 00, a tile 01, a tile 10, a tile 11, . . . , a tile 70, a tile 02, a tile 12, a tile 13, a tile 22, a tile 80, a tile 81, a tile 90, . . . , a tile 120, a tile 121, a tile 82, . . . , and a tile 91. Similarly, for each selected tile, values of elements of each tile are sequentially stored. Refer to the foregoing related descriptions. Details are not described herein again.

The tiles corresponding to the index array are stored in the foregoing manner. For ease of description, in the following, the tiles corresponding to the element value array are denoted as the second sub-blocks, and the tiles corresponding to the index array are denoted as third sub-blocks.

In this application, there is a mapping relationship between a plurality of second sub-blocks and a plurality of third sub-blocks corresponding to one submatrix. In the mapping relationship, the plurality of second sub-blocks and the plurality of third sub-blocks corresponding to the submatrix are in a one-to-one correspondence, and the one-to-one correspondence means that two sub-blocks at same locations correspond to each other. For example, division is performed by using a sub-block as a unit. A second sub-block (for example, the tile 00 in FIG. 14) in a row 0 and a column 0 in the element value array of the submatrix 1 corresponds to a third sub-block (not shown in FIG. 14, for example, denoted as a tile 00′) in a row 0 and a column 0 in the index array of the submatrix 1; a second sub-block (for example, the tile 01) in the row 0 and a column 1 in the element value array of the submatrix 1 corresponds to a third sub-block (for example, denoted as a tile 01′) in the row 0 and a column 1 in the index array of the submatrix 1; a second sub-block (for example, the tile 10) in a row 1 and the column 0 in the element value array corresponds to a third sub-block (for example, denoted as a tile 10′) in a row 1 and the column 0 in the index array of the submatrix 1; and the rest may be deduced by analogy.

Further, an embodiment of this application provides two manners. Manner 1: The second sub-blocks and the third sub-blocks are stored independently. For example, the plurality of second sub-blocks are stored in a segment of storage space A, and the plurality of third sub-blocks are stored in a segment of storage space B. In the foregoing selection order of the second sub-blocks, an arrangement order of the plurality of second sub-blocks in the storage space A may be: the tile 00, the tile 01, the tile 02, the tile 10, the tile 11, the tile 12, the tile 13, the tile 20, the tile 21, the tile 22, the tile 30, the tile 31, the tile 40, . . . , the tile 70, the tile 80, the tile 81, the tile 82, the tile 90, the tile 91, . . . , and the tile 121. A selection order of the third sub-blocks may be the same as the selection order of the second sub-blocks. For example, in the storage space B, an arrangement order of the plurality of third sub-blocks may be: the tile 00′, the tile 01′, a tile 02′, the tile 10′, a tile 11′, a tile 12′, a tile 13′, a tile 20′, a tile 21′, a tile 22′, a tile 30′, a tile 31′, a tile 40′, . . . , a tile 70′, a tile 80′, a tile 81′, a tile 82′, a tile 90′, a tile 91′, . . . , and a tile 121′.

Manner 2: The second sub-blocks and the third sub-blocks are alternately stored. For example, one second sub-block and a third sub-block corresponding to the second sub-block are used as one storage object. Refer to the foregoing selection order of the second sub-blocks. Selected second sub-blocks and third sub-blocks corresponding to the second sub-block are sequentially stored. For example, a storage order may be: the tile 00, the tile 00′, the tile 01, the tile 01′, the tile 02, a tile 02′, the tile 10, the tile 10′, the tile 11, a tile 11′, the tile 12, a tile 12′, and the rest may be deduced by analogy.

Specifically, the computing device 800 is used as an example, a storage location of the foregoing data may be the storage 802; may be a storage device other than the computing device 800; or may be that some data is stored in the storage 802, and the remaining data is stored in a storage device other than the computing device 800. This is not specifically limited.

In embodiments of this application, a value of a corresponding element in the original matrix and an original subscript of the element may be restored based on the second sub-block, the third sub-block corresponding to the second sub-block, the offset value pair of the submatrix, and the index vector of the submatrix.

### Storage Manner 2:

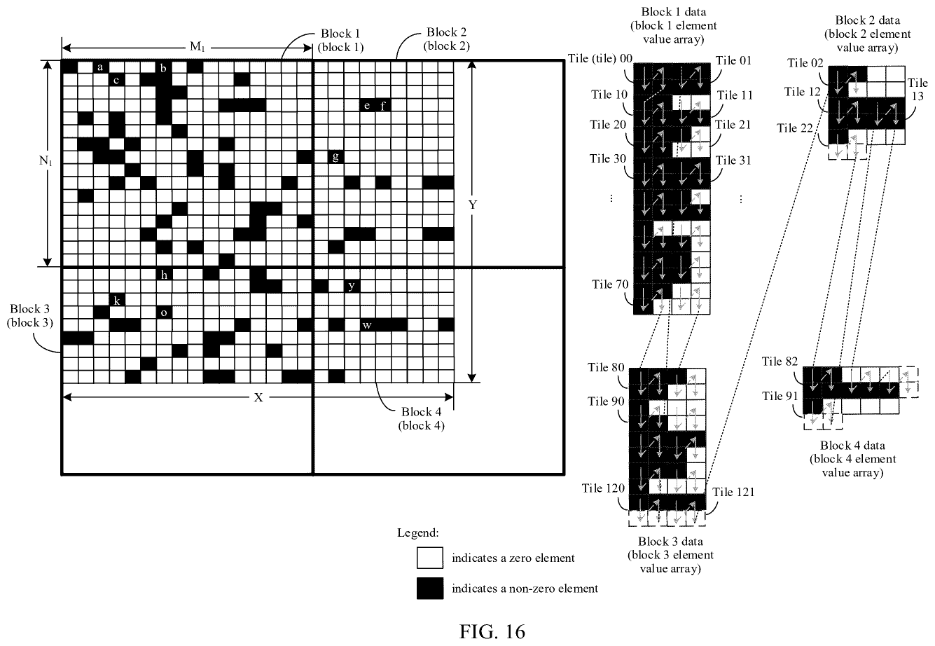

The element value array shown in FIG. 14 is still used as an example. In an embodiment, the second sub-blocks may be selected based on the column order. For example, in an implementation, for tiles included in a plurality of element value arrays belonging to a same sparse matrix, sub-blocks are selected based on the column order of the tiles. Optionally, a tile whose elements are all zeros may be removed, that is, the tile whose elements are all zeros is not stored. Details are not described below again. As shown in FIG. 16, a selection order of the tiles may be: a tile 00, a tile 10, a tile 20, a tile 30, a tile 40, a tile 50, a tile 60, a tile 70, a tile 80, a tile 90, a tile 100, a tile 110, a tile 120, a tile 01, a tile 11, a tile 21, a tile 31, . . . , a tile 81, a tile 91, a tile 101, . . . , a tile 121, a tile 02, a tile 12, a tile 22, a tile 82, a tile 91, a tile 13, a tile 83, and a tile 84.

Similarly, in another implementation, one submatrix is used as an object, and the tiles corresponding to the submatrices are sequentially stored based on the column order. Refer to the foregoing descriptions. Details are not described herein again. Regardless of the selection manner, for each selected tile, data of each tile is sequentially stored. Refer to the foregoing related descriptions. Details are not described herein again.

The tiles corresponding to the index array are sequentially stored in the foregoing manner. The tiles corresponding to the element value array and the tiles corresponding to the index array may be stored in serial or parallel.

According to the foregoing design, blocking is performed on the original matrix, and each submatrix obtained through blocking is compressed to obtain the compressed data of each submatrix. Tiling is then performed on the element value array and the index data in the compressed data to obtain the plurality of second sub-blocks, and the plurality of second sub-blocks are stored by using a second sub-block as a unit. In this application, the first sub-block is divided into the plurality of second sub-blocks, and a second sub-block whose elements are all zeros may be completely deleted. In this way, a sparse matrix with random distribution can be adapted to, and a high compression rate can be maintained under any sparse matrix.

In addition, in this application, a data bit width of a dedicated hardware accelerator (for example, the vector processor or the matrix processor) may be used in cooperation to perform tiling. For example, the data bit width of the hardware accelerator is n, and tiling may be performed on the first sub-block by using a sub-block with a scale of n×n as a unit. The tile (that is, the second sub-block) obtained through tiling is used as a storage unit, and storage is performed in the tile row direction or the tile column direction, so that memory access is facilitated, and at least one complete second sub-block can be read in one time of data access, thereby reducing a quantity of times of accessing a memory during sparse matrix calculation. Because lengths of all rows and lengths of all columns of the second sub-block are consistent, the second sub-block can provide a more friendly data access manner for the vector processor or the matrix processor. This can achieve good locality for access in the row order or column order, adapt to the dedicated hardware accelerator with high efficiency, and help improve a degree of parallelism of the sparse matrix calculation. On one hand, a plurality of complete second sub-blocks can be read in one time of memory access, and parallel computation may be performed on the plurality of second sub-blocks by using a plurality of dedicated hardware accelerators respectively. This can improve a degree of multi-core parallelism. On the other hand, because one second sub-block may provide a sufficient data amount for one dedicated hardware accelerator, the second sub-block is more suitable for the dedicated hardware accelerator to accelerate calculation. This helps improve a degree of intra-core parallelism of a single dedicated accelerator. For example, one tile with a scale of n×n is used as a unit, where for example, n=16, that is, a size of the tile is 16×16. It is assumed that one sparse matrix-sparse matrix multiplication operation is multiplying a 16×16 second sub-block A by a 16×16 second sub-block B. In this application, 16 groups of vectors of the second sub-block A and 16 groups of vectors of the second sub-block B can be read according to one vector instruction, and the vectors are aligned after being read. The dedicated hardware accelerator can complete 256 16×1 vector inner product calculations in one clock cycle. In this way, the dedicated hardware accelerator can achieve a degree of parallelism of 256, and performance can be greatly improved.

In conclusion, according to the storage method provided in embodiments of this application, data locality, a data compression rate, and a degree of parallelism of matrix calculation can be improved.

It should be noted that the foregoing uses the sparse matrix as an example for description. Alternatively, the original matrix in embodiments of this application may be the dense matrix, that is, the dense matrix is also applicable to the data format and the storage method provided in embodiments. In this way, formats can be unified, and calculation between the sparse matrix and the dense matrix can be accelerated, for example, multiplication between the sparse matrix and a dense vector, multiplication between the sparse matrix and a sparse vector, multiplication between the sparse matrix and the dense matrix, and multiplication between sparse matrices. Matrix compression rates, degrees of parallelism of matrix operations, and data locality in various scenarios can be extensively improved.

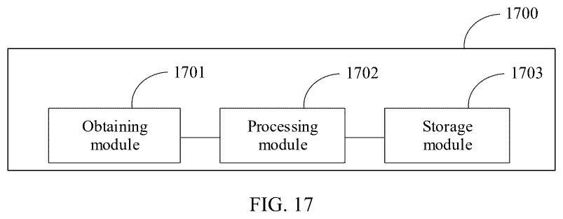

Based on a same inventive concept as the method embodiments, an embodiment of this application further provides a matrix storage apparatus. The apparatus is configured to perform the method in the method embodiment in FIG. 9. As shown in FIG. 17, the apparatus 1700 includes an obtaining module 1701, a processing module 1702, and a storage module 1703. Specifically, in the apparatus 1700, a connection is established between the modules through a communication path. In an application scenario, the storage 802 stores executable program code, and the processor 801 executes the executable program code to separately implement functions of the obtaining module 1701, the processing module 1702, and the storage module 1703, to implement the matrix storage method provided in embodiments.

The obtaining module 1701 is configured to obtain a plurality of first sub-blocks corresponding to an original matrix. The plurality of first sub-blocks are obtained after blocking is performed on the original matrix by using a sub-block with a scale of M₁×N₁ as a unit and a non-zero element in each submatrix obtained through blocking is compressed in a specified direction, where M₁ and N₁ are positive integers. For details, refer to descriptions of steps 901 to 903 in the method embodiment in FIG. 9. Details are not described herein again.

The processing module 1702 is configured to perform blocking on each first sub-block by using a sub-block with a scale of M₂×N₂ as a unit to obtain a plurality of second sub-blocks, where M₂ is a positive integer not greater than M₁, and N₂ is a positive integer not greater than N₁. For details, refer to the description of step 904 in the method embodiment in FIG. 9. Details are not described herein again.

The storage module 1703 is configured to sequentially store values of elements in each second sub-block. For details, refer to the description of step 905 in the method embodiment in FIG. 9. Details are not described herein again.

In a possible implementation, the specified direction is a row direction.

The obtaining module 1701 is further configured to obtain subscript data of each first sub-block, where the subscript data indicates a location, in the original matrix, of each element in the first sub-block. The subscript data of each first sub-block includes an offset value pair, an index matrix, and an index vector that correspond to the first sub-block. The offset value pair includes a first offset value and a second offset value, the first offset value indicates a first offset of an initial row of the first sub-block relative to a start row of the original matrix, and the second offset value indicates a second offset of an initial column of the first sub-block relative to a start column of the original matrix. A value of any element in the index matrix is equal to a difference between the second offset and a column index of an element that is in the original matrix corresponding to the first sub-block and that corresponds to the any element. A value of any element in the index vector indicates a difference between the first offset and a row index of an element that is in the original matrix corresponding to the first sub-block and that corresponds to the any element.

In a possible implementation, the specified direction is a column direction.

The obtaining module 1701 is further configured to generate subscript data of each first sub-block, where the subscript data indicates a location, in the original matrix, of each element in the first sub-block. The subscript data of each first sub-block includes an offset value pair, an index matrix, and an index vector that correspond to the first sub-block. The offset value pair includes a first offset value and a second offset value, the first offset value indicates a first offset of an initial row of the first sub-block relative to a start row of the original matrix, and the second offset value indicates a second offset of an initial column of the first sub-block relative to a start column of the original matrix. A value of any element in the index matrix is equal to a difference between the first offset and a row index of an element that is in the original matrix corresponding to the first sub-block and that corresponds to the any element. A value of any element in the index vector indicates a difference between the second offset and a column index of an element that is in the original matrix corresponding to the first sub-block and that corresponds to the any element.

In a possible implementation, the processing module 1702 is further configured to perform blocking on the index matrix corresponding to each first sub-block by using a sub-block with a scale of M₂×N₂ as a unit to obtain a plurality of third sub-blocks. The storage module 1703 is further configured to sequentially store values of elements in each third sub-block.

In a possible implementation, for each first sub-block, the plurality of second sub-blocks obtained based on the first sub-block one-to-one correspond to the plurality of third sub-blocks obtained based on the index matrix corresponding to the first sub-block; and a storage order of the third sub-blocks is the same as a storage order of the second sub-blocks.

In a possible implementation, when sequentially storing the values of the elements in each second sub-block, the storage module 1703 is specifically configured to: select each second sub-block by row or column, and store values of elements in each selected second sub-block by row, or store values of elements in each selected second sub-block by column.

In a possible implementation, each stored second sub-block includes at least one non-zero element. The storage module 1703 is further configured to: before sequentially storing the values of the elements in each second sub-block, remove a second sub-block whose elements are all zeros.

An embodiment of this application further provides a computer program product including instructions. The computer program product may be a software or program product that includes instructions and that can run on a computing device or be stored in any usable medium. When the computer program product runs on at least one computer device, the at least one computer device is enabled to perform the method in the embodiment in FIG. 9. Refer to the foregoing related descriptions. Details are not described herein again.

Embodiments of this application further provide a computer-readable storage medium. The computer-readable storage medium may be any usable medium that can be stored by a computing device, or a data storage device including one or more usable media. The usable medium may be a magnetic medium (for example, a floppy disk, a hard disk drive, or a magnetic tape), an optical medium (for example, a DVD), a semiconductor medium (for example, a solid state drive), or the like. The computer-readable storage medium includes instructions, and the instructions instruct a computing device to perform the method performed in the embodiment in FIG. 9. For details, refer to the foregoing related descriptions. Details are not described herein again.

Optionally, the computer-executable instructions in embodiments of this application may also be referred to as application program code. This is not specifically limited in embodiments of this application.

A person of ordinary skill in the art may understand that various numbers such as first and second in this application are merely used for differentiation for ease of description, and are not used to limit the scope of embodiments of this application or represent an order. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects. “At least one” means one or more. At least two means two or more. “At least one”, “any one”, or a similar expression thereof indicates any combination of the items, and includes a singular item (piece) or any combination of plural items (pieces). For example, at least one (piece or type) of a, b, or c may indicate: a, b, c, a and b, a and c, b and c, or a, b, and c, where a, b, and c may be singular or plural. The term “a plurality of” means two or more, and another quantifier is similar to this. In addition, an element that appears in singular forms “a”, “an”, and “the” does not mean “one or only one” unless otherwise specified in the context, but means “one or more”. For example, “a device” means one or more such devices.

All or some of foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by a computer, or a data storage device, like a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

The various illustrative logical units and circuits in embodiments of this application may implement or operate the described functions by using a general-purpose processor, a digital signal processor, an application-specific integrated circuit (ASIC), a field programmable gate array (FPGA) or another programmable logical apparatus, a discrete gate or transistor logic, a discrete hardware component, or a design of any combination thereof. The general-purpose processor may be a microprocessor. Optionally, the general-purpose processor may alternatively be any conventional processor, controller, microcontroller, or state machine. The processor may alternatively be implemented by a combination of computing apparatuses, such as a digital signal processor and a microprocessor, a plurality of microprocessors, one or more microprocessors with a digital signal processor core, or any other similar configuration.

Steps of the methods or algorithms described in embodiments of this application may be directly embedded into hardware, a software unit executed by a processor, or a combination thereof. The software unit may be stored in a RAM memory, a flash memory, a ROM memory, an EPROM memory, an EEPROM memory, a register, a hard disk, a removable magnetic disk, a CD-ROM, or a storage medium of any other form in the art. For example, the storage medium may connect to a processor, so that the processor may read information from the storage medium and write information to the storage medium. Optionally, the storage medium may be integrated into a processor. The processor and the storage medium may be disposed in the ASIC.

These computer program instructions may alternatively be loaded onto a computer or another programmable data processing device, so that a series of operations and steps are performed on the computer or the another programmable device to generate computer-implemented processing. Therefore, the instructions executed on the computer or the another programmable device provide steps for implementing a specific function in one or more processes in flowcharts and/or in one or more blocks in block diagrams.

Although this application is described with reference to specific features and embodiments thereof, it is clearly that various modifications and combinations may be made to them without departing from the spirit and scope of this application. Correspondingly, the specification and accompanying drawings are merely example description of this application defined by the appended claims, and are considered as any of and all modifications, variations, combinations or equivalents that cover the scope of this application. It is clearly that a person skilled in the art can make various modifications and variations to this application without departing from the scope of this application. This application is intended to cover these modifications and variations of this application provided that they fall within the scope of the claims of this application and their equivalent technologies.

1. A matrix storage method, comprising:
obtaining a plurality of first sub-blocks corresponding to an original matrix, wherein the plurality of first sub-blocks are obtained after blocking is performed on the original matrix by using a sub-block with a scale of M₁×N₁ as a unit and a non-zero element in each submatrix obtained through blocking is compressed in a specified direction, wherein M₁ and N₁ are positive integers;
performing blocking on each first sub-block by using a sub-block with a scale of M₂×N₂ as a unit to obtain a plurality of second sub-blocks, wherein M₂ is a positive integer not greater than M₁, and N₂ is a positive integer not greater than N₁; and
storing values of elements in each second sub-block.

2. The method according to claim 1, wherein the specified direction is a row direction; and
the method further comprises:
obtaining subscript data of each first sub-block, wherein the subscript data indicates a location, in the original matrix, of each element in the first sub-block, wherein
the subscript data of each first sub-block comprises an offset value pair, an index matrix, and an index vector that correspond to the first sub-block; the offset value pair comprises a first offset value and a second offset value, the first offset value indicates a first offset of an initial row of the first sub-block relative to a start row of the original matrix, and the second offset value indicates a second offset of an initial column of the first sub-block relative to a start column of the original matrix; a value of any element in the index matrix is equal to a difference between the second offset and a column index of an element that is in the original matrix corresponding to the first sub-block and that corresponds to the any element; and a value of any element in the index vector indicates a difference between the first offset and a row index of an element that is in the original matrix corresponding to the first sub-block and that corresponds to the any element.

3. The method according to claim 1, wherein the specified direction is a column direction; and
the method further comprises:
obtaining subscript data of each first sub-block, wherein the subscript data indicates a location, in the original matrix, of each element in the first sub-block, wherein
the subscript data of each first sub-block comprises an offset value pair, an index matrix, and an index vector that correspond to the first sub-block; the offset value pair comprises a first offset value and a second offset value, the first offset value indicates a first offset of an initial row of the first sub-block relative to a start row of the original matrix, and the second offset value indicates a second offset of an initial column of the first sub-block relative to a start column of the original matrix; a value of any element in the index matrix is equal to a difference between the first offset and a row index of an element that is in the original matrix corresponding to the first sub-block and that corresponds to the any element; and a value of any element in the index vector indicates a difference between the second offset and a column index of an element that is in the original matrix corresponding to the first sub-block and that corresponds to the any element.

4. The method according to claim 2, wherein the method further comprises:
performing blocking on the index matrix corresponding to each first sub-block by using a sub-block with a scale of M₂×N₂ as a unit, to obtain a plurality of third sub-blocks; and
sequentially storing values of elements in each third sub-block.

5. The method according to claim 4, wherein for each first sub-block, the plurality of second sub-blocks obtained based on the first sub-block one-to-one correspond to the plurality of third sub-blocks obtained based on the index matrix corresponding to the first sub-block; and
a storage order of the third sub-blocks is the same as a storage order of the second sub-blocks.

6. The method according to claim 1, wherein the storing values of elements in each second sub-block comprises:
selecting each second sub-block by row or column, and storing values of elements in each selected second sub-block by row, or storing values of elements in each selected second sub-block by column.

7. The method according to claim 1, wherein each stored second sub-block comprises at least one non-zero element.

8. A matrix storage apparatus, comprising:
at least one processor; and
at least one memory storing a program or instructions that, when executed by the at least one processor, cause the matrix storage apparatus to:
obtain a plurality of first sub-blocks corresponding to an original matrix, wherein the plurality of first sub-blocks are obtained after blocking is performed on the original matrix by using a sub-block with a scale of M₁×N₁ as a unit and a non-zero element in each submatrix obtained through blocking is compressed in a specified direction, wherein M₁ and N₁ are positive integers; and
perform blocking on each first sub-block by using a sub-block with a scale of M₂×N₂ as a unit to obtain a plurality of second sub-blocks, wherein M₂ is a positive integer not greater than M₁, and N₂ is a positive integer not greater than N₁; and
sequentially store values of elements in each second sub-block.

9. The apparatus according to claim 8, wherein the specified direction is a row direction; and the program or instructions, when executed by the at least one processor, cause the matrix storage apparatus to:
obtain subscript data of each first sub-block, wherein the subscript data indicates a location, in the original matrix, of each element in the first sub-block, wherein
the subscript data of each first sub-block comprises an offset value pair, an index matrix, and an index vector that correspond to the first sub-block; the offset value pair comprises a first offset value and a second offset value, the first offset value indicates a first offset of an initial row of the first sub-block relative to a start row of the original matrix, and the second offset value indicates a second offset of an initial column of the first sub-block relative to a start column of the original matrix; a value of any element in the index matrix is equal to a difference between the second offset and a column index of an element that is in the original matrix corresponding to the first sub-block and that corresponds to the any element; and a value of any element in the index vector indicates a difference between the first offset and a row index of an element that is in the original matrix corresponding to the first sub-block and that corresponds to the any element.

10. The apparatus according to claim 8, wherein the specified direction is a column direction; and the program or instructions, when executed by the at least one processor, cause the matrix storage apparatus to:
generate subscript data of each first sub-block, wherein the subscript data indicates a location, in the original matrix, of each element in the first sub-block, wherein
the subscript data of each first sub-block comprises an offset value pair, an index matrix, and an index vector that correspond to the first sub-block; the offset value pair comprises a first offset value and a second offset value, the first offset value indicates a first offset of an initial row of the first sub-block relative to a start row of the original matrix, and the second offset value indicates a second offset of an initial column of the first sub-block relative to a start column of the original matrix; a value of any element in the index matrix is equal to a difference between the first offset and a row index of an element that is in the original matrix corresponding to the first sub-block and that corresponds to the any element; and a value of any element in the index vector indicates a difference between the second offset and a column index of an element that is in the original matrix corresponding to the first sub-block and that corresponds to the any element.

11. The apparatus according to claim 9, wherein the program or instructions, when executed by the at least one processor, cause the matrix storage apparatus to:
perform blocking on the index matrix corresponding to each first sub-block by using a sub-block with a scale of M₂×N₂ as a unit, to obtain a plurality of third sub-blocks; and
sequentially store values of elements in each third sub-block.

12. The apparatus according to claim 11, wherein for each first sub-block, the plurality of second sub-blocks obtained based on the first sub-block one-to-one correspond to the plurality of third sub-blocks obtained based on the index matrix corresponding to the first sub-block; and a storage order of the third sub-blocks is the same as a storage order of the second sub-blocks.

13. The apparatus according to claim 8, wherein the program or instructions, when executed by the at least one processor, cause the matrix storage apparatus to: when sequentially storing the values of the elements in each second sub-block, the select each second sub-block by row or column, and store values of elements in each selected second sub-block by row, or store values of elements in each selected second sub-block by column.

14. The apparatus according to claim 8, wherein each stored second sub-block comprises at least one non-zero element.

15. A non-transitory computer-readable storage medium, wherein the non-transitory computer-readable storage medium stores instructions, and when the instructions are run on a computer, the computer is enabled to:
obtain a plurality of first sub-blocks corresponding to an original matrix, wherein the plurality of first sub-blocks are obtained after blocking is performed on the original matrix by using a sub-block with a scale of M₁×N₁ as a unit and a non-zero element in each submatrix obtained through blocking is compressed in a specified direction, wherein M₁ and N₁ are positive integers;
perform blocking on each first sub-block by using a sub-block with a scale of M₂×N₂ as a unit to obtain a plurality of second sub-blocks, wherein M₂ is a positive integer not greater than M₁, and N₂ is a positive integer not greater than N₁; and
store values of elements in each second sub-block.

16. The non-transitory computer-readable storage medium according to claim 15, wherein the specified direction is a row direction; and when the instructions are run on the computer, the computer is further enabled to:
obtain subscript data of each first sub-block, wherein the subscript data indicates a location, in the original matrix, of each element in the first sub-block, wherein
the subscript data of each first sub-block comprises an offset value pair, an index matrix, and an index vector that correspond to the first sub-block; the offset value pair comprises a first offset value and a second offset value, the first offset value indicates a first offset of an initial row of the first sub-block relative to a start row of the original matrix, and the second offset value indicates a second offset of an initial column of the first sub-block relative to a start column of the original matrix; a value of any element in the index matrix is equal to a difference between the second offset and a column index of an element that is in the original matrix corresponding to the first sub-block and that corresponds to the any element; and a value of any element in the index vector indicates a difference between the first offset and a row index of an element that is in the original matrix corresponding to the first sub-block and that corresponds to the any element.

17. The non-transitory computer-readable storage medium according to claim 15, wherein the specified direction is a column direction; and when the instructions are run on the computer, the computer is further enabled to:
obtain subscript data of each first sub-block, wherein the subscript data indicates a location, in the original matrix, of each element in the first sub-block, wherein
the subscript data of each first sub-block comprises an offset value pair, an index matrix, and an index vector that correspond to the first sub-block; the offset value pair comprises a first offset value and a second offset value, the first offset value indicates a first offset of an initial row of the first sub-block relative to a start row of the original matrix, and the second offset value indicates a second offset of an initial column of the first sub-block relative to a start column of the original matrix; a value of any element in the index matrix is equal to a difference between the first offset and a row index of an element that is in the original matrix corresponding to the first sub-block and that corresponds to the any element; and a value of any element in the index vector indicates a difference between the second offset and a column index of an element that is in the original matrix corresponding to the first sub-block and that corresponds to the any element.

18. The non-transitory computer-readable storage medium according to claim 16, when the instructions are run on the computer, the computer is further enabled to:
perform blocking on the index matrix corresponding to each first sub-block by using a sub-block with a scale of M₂×N₂ as a unit, to obtain a plurality of third sub-blocks; and
sequentially store values of elements in each third sub-block.

19. The non-transitory computer-readable storage medium according to claim 18, wherein for each first sub-block, the plurality of second sub-blocks obtained based on the first sub-block one-to-one correspond to the plurality of third sub-blocks obtained based on the index matrix corresponding to the first sub-block; and
a storage order of the third sub-blocks is the same as a storage order of the second sub-blocks.

20. The non-transitory computer-readable storage medium according to claim 18, wherein when storing values of elements in each second sub-block, the computer is enabled to:
select each second sub-block by row or column, and store values of elements in each selected second sub-block by row, or store values of elements in each selected second sub-block by column.
